(19) United States
(12) Patent Application Publication
(10) Pub. No.: US 2019/0254274 A1
(43) Pub. Date: Aug. 22, 2019

(54) COMPOSITE MATERIALS DESIGNED TO POSSES BIO-ACTIVE PROPERTIES AND SYNTHESIS AND USES THEREO

(71) Applicant: ADA Foundation, Chicago, IL (US)

(72) Inventors: Stanislav Frukhtbeyn, Montgomery Village, MD (US); Thomas C. Hart, Potomac, MD (US); Michael S. Valerio, Rockville, MD (US); Jeffrey J. Kim, Gaithersburg, MD (US); Gili Kaufman, North Potomac, MD (US)

(73) Assignee: ADA Foundation, Chicago, IL (US)

(21) Appl. No.: 16/280,887

(22) Filed: Feb. 20, 2019

Related U.S. Application Data
(60) Provisional application No. 62/633,217, filed on Feb. 21, 2018.

(51) Int. Cl. A01N 25/26; A01N 59/16

(52) U.S. Cl. CPC A01N 25/26; C09D 5/16; A01N 59/16

(57) ABSTRACT

A bio-active composite material includes one or more organic molecules, each organic molecule including a metal coordinating functional group and an inorganic core attached to the organic molecule. The inorganic core includes one or more metals. The metals may be noble metals and/or non-noble metals. The non-noble metals may be alkali, alkaline earth, transition, post-transition, and metalloid materials. The organic molecule and inorganic core are attached by a covalent bond or a non-covalent bond.

### RELATED APPLICATIONS

This application claims the benefit of U.S. Provisional Patent Application 62/633,217, filed Feb. 21, 2018, and entitled “COMPOSITE MATERIALS DESIGNED TO POSSES BIO-ACTIVE PROPERTIES AND SYNTHESIS AND USES THEREOF.” The disclosure of this provisional patent application is incorporated by reference.

### BACKGROUND

Currently, targeted delivery of biomolecules is hindered by several factors. Biomolecules do not remain at their delivery site for long, requiring multiple injections where possible or limited to only one delivery (such as at a surgical site). Encapsulation of biomolecules can control their release, but can interfere with physicochemical properties of restorative materials into which they are added. Biomolecules adsorbed on target surfaces exhibit similar problems.

### SUMMARY

Disclosed are formulations of new bio-active composite materials through concomitant or step-wise processes, whereby covalent/non-covalent bonding of organic molecules to the surface of inorganic particles occurs, with the bio-active materials retaining bio-functionality of its organic component. Also disclosed are methods of synthesis and uses of the bio-active materials.

Moreover, disclosed is a bio-active composite material that includes one or more organic molecules, each organic molecule including a metal coordinating functional group and an inorganic core attached to the organic molecule. The inorganic core includes one or more metals. The metals may be noble metals and/or non-noble metals. The non-noble metals may be alkali, alkaline earth, transition, post-transition, and metalloid materials. The organic molecule and inorganic core are attached using a covalent bond or a non-covalent bond.

Further, disclosed is a bio-active composition for use on a target surface, comprising an organic layer of one or more organic molecules consisting of one or more functional groups, the one or more functional groups consisting of one or more of a metal coordinating functional group, and one or more of a carboxylic acid or orthophosphoric or hydroxyl group/groups, amines, amides, and nitrogen-containing aromatics, wherein the functional groups comprise one or more of alkyl phosphine oxides, alkyl phosphonic acids, alkyl phosphines, saturated and unsaturated fatty acids and their derivatives; an inorganic core of one or more inorganic molecules, the inorganic molecules comprising a metal or a mixture of metals, the metals chosen from a group consisting of noble metals and non-noble metals; and a chemical bond between the organic layer and the inorganic core.

Still further, disclosed is a bio-active composite material, comprising an organic molecule or molecules having a set of properties, the organic molecule or molecules, comprising a metal coordinating functional group; and an inorganic core attached to the organic molecule, the inorganic core comprising one or more metals, wherein the metals are chosen from one of a group consisting of noble metals and non-noble metals, the non-noble metals comprising one or more of alkali, alkaline earth, transition, post-transition, and metalloid metals, wherein the organic molecule and inorganic core are attached using one of a covalent bond and a non-covalent bond, wherein the bio-active composite material is used alone, or in conjunction with other materials, or is deposited on a target surface, and wherein the organic molecule or molecules is controllably released, through hydrolysis of the bond or dissolution of the inorganic core, from the bio-active composite material, the organic molecule or molecules retaining the set of properties. The bio-active composite material further includes additional reacting components added during formation of the bio-active material to alter the set of properties of the inorganic molecule or molecules, the additional reacting properties comprising halogen (fluoride, chloride, bromide, iodide) salts and transition/actinide/lanthanide salts.

### DESCRIPTION OF THE DRAWINGS

The detailed description refers to the following figures in which like numerals refer to like objects, and in which:

FIGS. 1A-1D illustrate example synthesis plans for bio-active composite materials;

FIGS. 2A-2C illustrate example dissolution and hydrolysis of bonds between inorganic cores and bonded organic functional groups;

FIG. 3 illustrates an additional example synthesis plan for bio-active composite materials;

FIGS. 4-12 illustrate confirmation of an experimental series to confirm the synthesis and composition of the herein disclosed bio-active composite materials;

FIGS. 13-21 illustrate results of an experimental series to confirm the effectiveness of the herein disclosed bio-active composite materials as an anti-inflammatory composition;

FIGS. 22-30 illustrate the results of an experimental series to confirm the effectiveness of the herein disclosed bio-active composite materials as an anti-microbial composition; and

FIGS. 31A-38 illustrate the results of an experimental series to confirm the effectiveness of the herein disclosed bio-active composite materials as a bio-mineralization composition.

### DETAILED DESCRIPTION

Biomolecules (bio-active materials) perform vital functions in biology such as in bioanalysis and disease therapy. One particular application attempts to use targeted delivery of drugs to treat cancer. However, current, targeted delivery of biomolecules is hindered by several factors. Biomolecules do not remain at their delivery site for long, requiring multiple injections where possible or limited to only one delivery (such as at a surgical site). Encapsulation of biomolecules can control their release, but can interfere with physicochemical properties of restorative materials into which they are added. Biomolecules adsorbed on a target surface exhibit similar problems.

To address deficiencies in current targeted delivery systems, disclosed herein are bio-active composite materials composed of a bioactive organic molecule or molecules that may be covalently/non-covalently bonded to an inorganic core (inorganic particle) and that may control bio-active molecule release through hydrolysis of the covalent bond and/or dissolution of the inorganic core (which depend on the environment, such as pH, reactive species present and particle composition/size/surface area). The inorganic core composition may be designed to achieve controlled release of functional groups and/or to integrate with a restorative material into which it will be added, thus controlling its effects on the physicochemical properties of the restorative material. Furthermore, simultaneous introduction of a range of bio-active molecules (each designed to target a specific objective) is possible.

Also disclosed are examples of preparation and formulation of novel bio-active composite materials. These materials are formed through covalent and non-covalent bonding of organic molecules or mixtures of organic molecules to a metal cation or a mixture of metal cations. The organic molecules may contain metal coordinating functional groups. The metal coordinating functional groups may be alkyl phosphine oxides, alkyl phosphonic acids, alkyl phosphines, saturated and unsaturated fatty acids and their derivatives, and/or organic molecules containing carboxylic acid or orthophosphoric or hydroxyl group/groups, amines, amides, nitrogen-containing aromatics. The metal cations or a mixture of metal cations in turn are reduced (in case of noble metal cations only: Ru, Rh, Pd, Ag, Os, Ir, Pt, Au), are oxidized (in the case of all other metal cations: alkali, alkaline earth, transition, post-transition, and metalloid cations, when oxidizing species are present), or react with anionic species such as CO₃²⁻, PO₄³⁻, etc. (in the case of all metal cations when cationic and anionic species are present and can form crystals) to precipitate as particles or form deposits on a target surface. The particles or deposits may be composed of inorganic cores and an organic layer or layers covalently or non-covalently bonded to the surface of the inorganic cores.

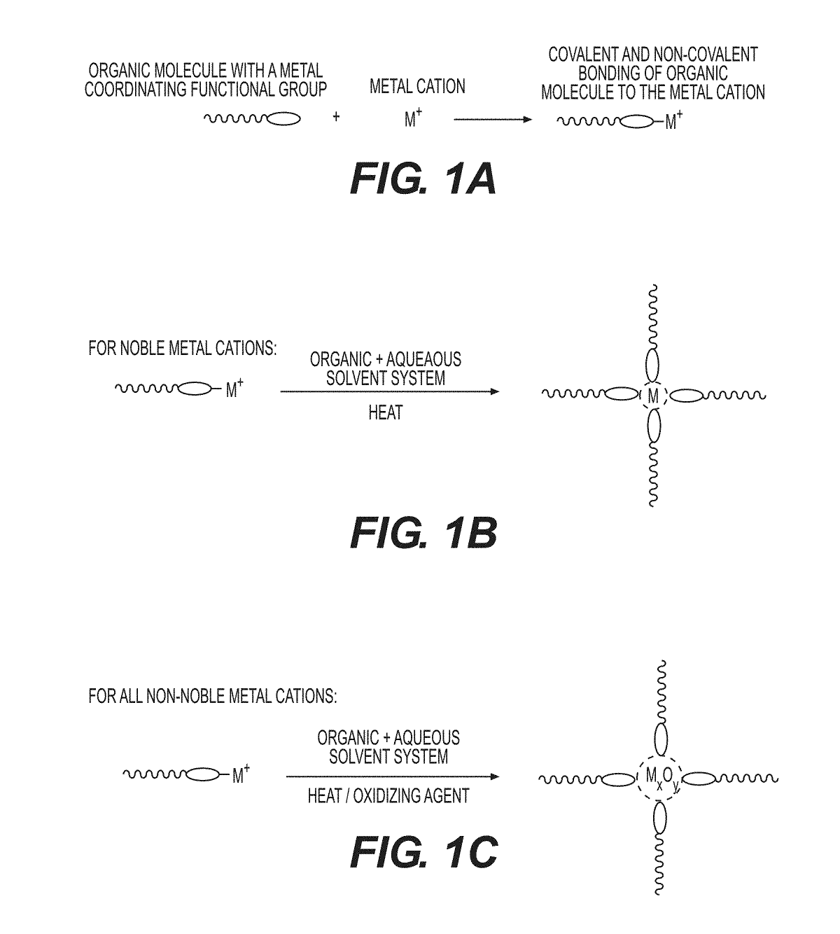

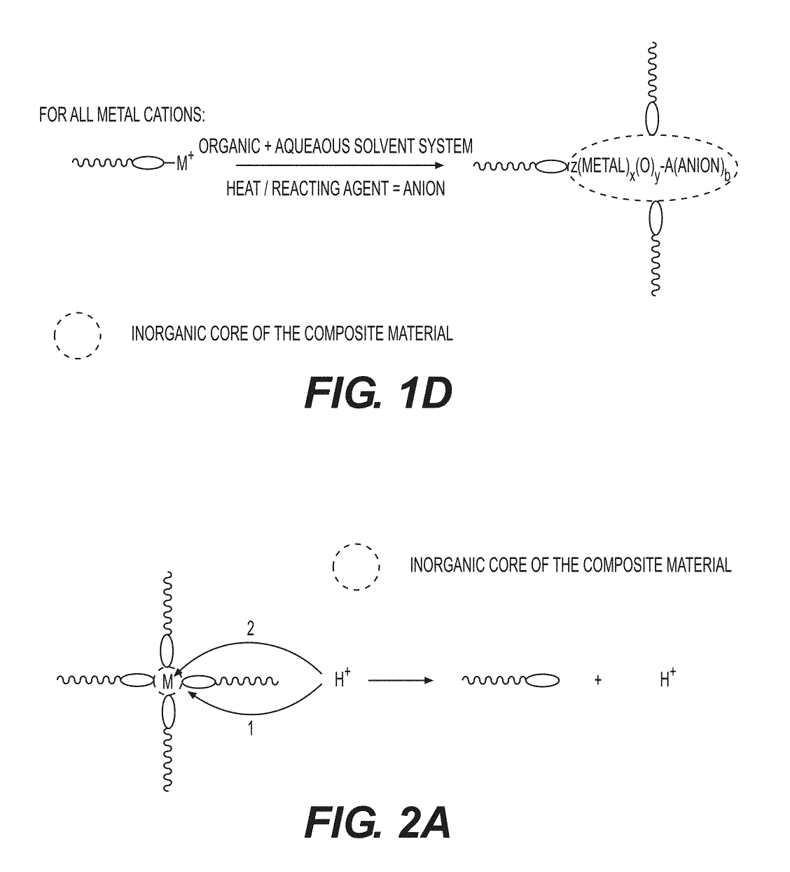

FIG. 1A illustrates the general synthesis plan for the bio-active composite materials. As can be seen, an organic molecule with a metal coordinating functional group complexes with a metal cation M. The metal cation forms the inorganic core of the bio-active composite material. The bio-active composite material then may be caused to precipitate or form deposits on a target surface (not shown).

FIGS. 1B-1D show, respectively, the specific synthesis plans for reduction of noble metal cations, oxidation of non-noble metal cations, and reaction of metal cations when cationic and anionic species are present and can form crystals. In the case of noble metal reduction, shown in FIG. 1B, the inorganic core will be composed of noble metals used (Ru, Rh, Pd, Ag, Os, Ir, Pt, Au). In the case of oxidation of non-noble metal cations, shown in FIG. 1C, the inorganic core will be composed of metal oxides with a general formula of (Metal)ₓO_{y}, where x and y are stoichiometric coefficients (for example CaO, TiO₂ etc.). In the case of reaction of metal cations with anionic species, shown in FIG. 1D, the inorganic core will be composed of their reaction products (for example reaction of Ca²⁺ cations with CO₃²⁻ anions will produce CaCO₃ cores; another example is the reaction of Ca²⁺ cations with PO₄³⁻ anions, which produces Ca₁₀(PO₄)₆(OH) cores). These cores may be described by a general formula Z(Metal)ₓ(O)_{y} A(anion)_{b}, where x, y, Z, A, b are stoichiometric coefficients

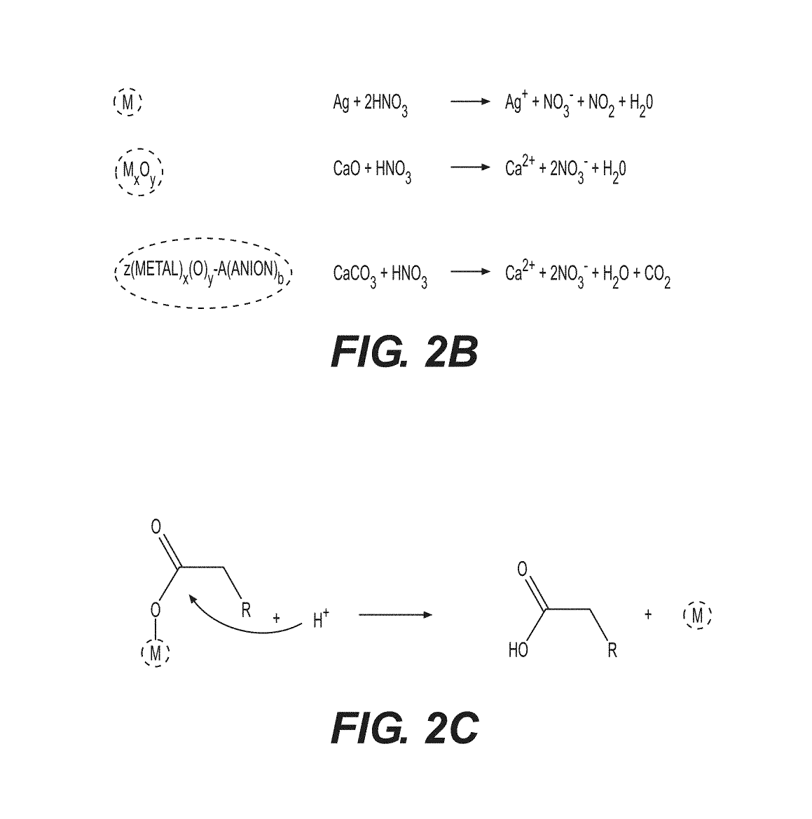

FIGS. 2A-2C illustrate example dissolution and hydrolysis of bonds between inorganic cores and bonded organic functional groups. Referring to FIG. 2A, release of the organic bio-active component is governed through dissolution of the inorganic core and hydrolysis of the bond between the organic molecule (1) and the inorganic core (2). The dissolution rate of the inorganic core and hydrolysis of the covalent bond between the inorganic core and the organic component depends on the pH of the surrounding environment, the reactive species present, and the inorganic core surface area. For example, both processes 1 and 2 shown in FIG. 2A are strongly dependent on the pH of the environment. At physiological conditions with neutral to slightly basic pH levels, hydrolysis and dissolution of the composite materials proceeds slowly. As acidity increases, both processes accelerate. FIGS. 2B and 2C illustrate examples of inorganic core dissolution reactions and an example of hydrolysis of the bond between the organic molecule and the inorganic core. The inorganic core composition may be designed to achieve: (1) optimum integration with restorative materials into which the inorganic core will be added (controlling its effects on the physicochemical properties of the restorative materials); (2) optimum release of bio-active functional groups; and (3) simultaneous introduction of a range of bio-active organic and inorganic functional moieties (each designed to target a specific objective).

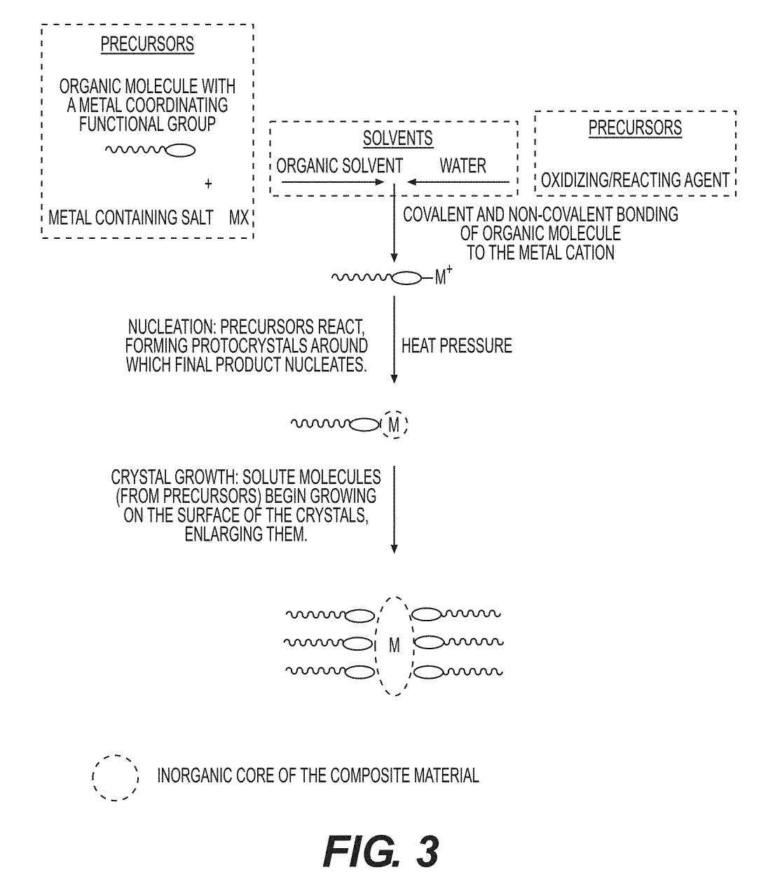

FIG. 3 illustrates an example synthesis plan in more detail. As shown in FIG. 3, metal salts (for example, CaNO₃, CaCl₂, AgNO₃, etc.) are dissolved in organic solvents (for example, alcohols).

In step 1, organic bio-active molecules (organic molecules containing metal coordinating groups, such as alkyl phosphine oxides, alkyl phosphonic acids, alkyl phosphines, saturated and unsaturated fatty acids and their derivatives, organic molecules containing carboxylic acid or orthophosphoric or hydroxyl group/groups, amines, amides, nitrogen-containing aromatics) are added to an organic solvent containing dissolved metal salt or salts.

In step 2, aqueous solutions containing oxidizing agents (such as HNO₃, HCl, etc.) or reacting agents (such as Na₃PO₄, Na₂CO₃, etc.) are prepared by dissolving appropriate agents in water. In the case of noble metal salts, the aqueous solutions contain only water or reacting agents. Alternatively, noble metal salts may be dissolved in an aqueous component instead of an organic solvent.

In step 3, additional reacting components may be added to alter the inorganic core material surface/size properties or composition. For example, fluoride salts (NaF, NH₄F etc.) may be added if fluoride incorporation into the inorganic core is desired, or transition/lanthanide salts can be added if lanthanoid/actinoid element doping may be desired to change the aspect ratio of the inorganic core.

In step 4, the solution (from step 3) is added to the organic phase (from step 2) and mixed. The reaction mixture is heated to 20-300° C. in a vessel purged with inert gas, such as N₂ or Ar (this reduces unwanted oxidation of the organic bio-active surfactant molecule by oxygen in the atmosphere or dissolved in solvents; for example, unsaturated fatty acids or their derivatives are susceptible to this type of oxidation and purge with inert gases minimizes unwanted oxidation of the organic bio-active molecule) at atmospheric pressure or in a sealed autoclave reaction vessel (where pressure builds to >1 atm). To reduce thermal and oxidative degradation of organic bio-active molecules, free-radical scavengers (such as Butylated Hydroxytoluene, α-tocopherol, etc.) and peroxide scavengers (such as dimethyl sulfoxide etc.) may be added to the reaction mixture. Over time, inorganic metal cations-organic bio-active molecule complexes are formed and then reduced (containing noble metal cations and solvents), oxidized (containing all non-noble metal cations, oxidizers and solvents) or reacted (all metal cations and solvents when cationic and anionic species are present and can form crystals), and inorganic cores functionalized with organic moieties are formed and precipitated/deposited. The reaction time may be varied from hours to weeks. The extent of covalent and non-covalent bonding of organic bio-active moieties and the aspect ratio of the inorganic core depends on reaction conditions (temperature, reaction time, volume, concentration/type of each ingredient, amount and types of solvents used, pressure, etc.). Functionalized composite materials may be collected by centrifugation or filtration (depending on their size) and may undergo multiple washes with organic solvents (for example alcohols) designed to remove any un-attached organic molecules. After multiple washing steps, functionalized composite materials may be dried (under vacuum or lyophilized) or dispersed in a desired solvent (water, organic solvents such as alcohols, dimethyl sulfoxide, etc.).

When heated, biomolecules containing unsaturated bonds oxidize, leading to structural changes and loss of bio-functionality. This may be overcome with careful temperature/atmospheric control, addition of free radical scavengers (primary anti-oxidants) and peroxide scavengers (secondary anti-oxidants). The inventors confirmed this result using Butylated Hydroxytoluene or α-tocopherol as primary antioxidants and dimethyl sulfoxide as a secondary antioxidant for Hydroxylapatite (inorganic core)-Docosahexaenoic acid (organic bio-active component) synthesis.

### EXPERIMENTS

### Experimental Series 1: Synthesis and Characterization of Bio-Active Composite Materials

All chemicals were purchased from commercial sources and were used without further purification.

### Example 1

Synthesis of bio-active composite material Hydroxyapatite (10CaO.3P₂O₅.H₂O═Ca₁₀(PO₄)₆(OH)₂, inorganic core) functionalized with (9Z)-Octadec-9-enoic acid (Oleic acid) (organic bio-active component).

One (1) gram of Oleic acid (OA, organic bio-active molecule) was mixed with 18 mL of ethanol (organic solvent) by magnetic agitation. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (HA-OA) was dried under vacuum overnight and characterized.

### Example 2

Synthesis of bio-active composite material Hydroxyapatite (10CaO.3P₂O₅.H₂O═Ca₁₀(PO₄)₆(OH)₂, inorganic core) functionalized with (9Z)-Octadec-9-enoic acid (Oleic acid) (organic bio-active component) utilizing increased starting amount of Oleic acid.

Four (4) grams of Oleic acid (OA, organic bio-active molecule) was mixed with 16 mL of ethanol (organic solvent) by magnetic agitation. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (HA-OA) was dried under vacuum overnight and characterized.

### Example 3

Synthesis of bio-active composite material Hydroxyapatite (10CaO.3P₂O₅.H₂O═Ca₁₀(PO₄)₆(OH)2, inorganic core) functionalized with (9Z)-Octadec-9-enoic acid (Oleic acid) (organic bio-active component) in the presence of Octadecylamine (surfactant).

One (1) gram of Oleic acid (OA, organic bio-active molecule) and 0.5 grams of Octadecylamine (surfactant) was mixed with 18 mL of ethanol (organic solvent) by magnetic agitation. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (HA-OA) was dried under vacuum overnight and characterized.

### Example 4

Synthesis of bio-active composite material Hydroxyapatite (10CaO.3P₂O₅.H₂O═Ca₁₀(PO₄)₆(OH)₂, inorganic core) functionalized with (9Z)-Octadec-9-enoic acid (Oleic acid) (organic bio-active component) in the presence of Polyethylene glycol (surfactant).

One (1) gram of Oleic acid (OA, organic bio-active molecule) and 0.5 grams of Polyethylene glycol (surfactant, MW≈20,000 Da) was mixed with 18 mL of ethanol (organic solvent) by magnetic agitation. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed with 40 mL of ethanol three times to remove any unreacted precursors. The bio-active composite material (HA-OA) was dried under vacuum overnight and characterized.

### Example 5

Synthesis of bio-active composite material Hydroxyapatite (10CaO.3P₂O₅.H₂O═Ca₁₀(PO₄)₆(OH)₂, inorganic core) functionalized with (9Z)-Octadec-9-enoic acid (Oleic acid) (organic bio-active component) in the presence of Ethanolamine (surfactant).

One (1) gram of Oleic acid (OA, organic bio-active molecule) and 0.12 mL of Ethanolamine (surfactant) was mixed with 18 mL of ethanol (organic solvent) by magnetic agitation. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (HA-OA) was dried under vacuum overnight and characterized.

### Example 6

Synthesis of bio-active composite material Hydroxyapatite (10CaO.3P₂O₅.H₂O═Ca₁₀(PO₄)₆(OH)₂, inorganic core) functionalized with 4Z, 7Z, 10Z, 13Z, 16Z, 19Z)-docosa-4,7,10,13,16,19-hexaenoic acid (Docosahexaenoic acid) (organic bio-active component).

One (1) gram of Docosahexaenoic acid (DHA, organic bio-active molecule) was mixed with 18 mL of ethanol (organic solvent) by magnetic agitation. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (HA-DHA) was dried under vacuum overnight and characterized.

### Example 7

Synthesis of bio-active composite material Hydroxyapatite (10CaO.3P₂O₅.H₂O═Ca₁₀(PO₄)₆(OH)₂, inorganic core) functionalized with 4Z, 7Z, 10Z, 13Z, 16Z, 19Z)-docosa-4,7,10,13,16,19-hexaenoic acid (Docosahexaenoic acid) (organic bio-active component) in the presence of (2R)-2,5,7,8-Tetramethyl-2-[(4R,8R)-(4,8,12-trimethyltridecyl)]chroman-6-ol (α-Tocopherol) anti-oxidant.

One hundred (100) mg of anti-oxidant α-Tocopherol and 1 gram of Docosahexaenoic acid (DHA, organic bio-active molecule) was mixed with 18 mL of ethanol (organic solvent) by magnetic agitation. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (HA-DHA) was dried under vacuum overnight and characterized.

### Example 8

Synthesis of bio-active composite material Hydroxyapatite (10CaO.3P₂O₅.H₂O═Ca₁₀(PO₄)₆(OH)₂, inorganic core) functionalized with (9Z)-Octadec-9-enoic acid (Oleic acid) (organic bio-active component) in the presence of 2,6-Di-tert-butyl-4-methylphenol (Butylated Hydroxytoluene) and Dimethyl sulfoxide anti-oxidants.

Eight-tenths (0.8) of a gram of Butylated Hydroxytoluene (BHT, primary-anti-oxidant) was dissolved in 18 mL of ethanol (organic solvent). One-half (0.5) mL of Dimethyl Sulfoxide (DMSO, secondary anti-oxidant) and 1 gram of Oleic acid (OA, organic bio-active molecule) was added to this mixture and magnetically agitated. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (HA-OA) was dried under vacuum overnight and characterized.

### Example 9

Synthesis of bio-active composite material Hydroxyapatite (10CaO.3P₂O₅.H₂O═Ca₁₀(PO₄)₆(OH)₂, inorganic core) functionalized with 4Z, 7Z, 10Z, 13Z, 16Z, 19Z)-docosa-4,7,10,13,16,19-hexaenoic acid (Docosahexaenoic acid) (organic bio-active component) in the presence of 2,6-Di-tert-butyl-4-methylphenol (Butylated Hydroxytoluene) and Dimethyl sulfoxide anti-oxidants.

Eight-tenths (0.8) of a gram of Butylated Hydroxytoluene (BHT, primary-anti-oxidant) was dissolved in 18 mL of ethanol (organic solvent). One half (0.5) mL of Dimethyl Sulfoxide (DMSO, secondary anti-oxidant) and 1 gram of Docosahexaenoic acid (DHA, organic bio-active molecule) was added to this mixture and magnetically agitated. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (HA-DHA) was dried under vacuum overnight and characterized.

### Example 10

Synthesis of bio-active composite material Hydroxyapatite (10CaO.3P₂O₅.H₂O═Ca₁₀(PO₄)₆(OH)₂, inorganic core) functionalized with (9Z, 12Z, 15Z)-octadeca-9,12,15-trienoic acid (a-Linolenic acid) (organic bio-active component) in the presence of 2,6-Di-tert-butyl-4-methylphenol (Butylated Hydroxytoluene) and Dimethyl sulfoxide anti-oxidants.

Eight-tenths (0.8) of a gram of Butylated Hydroxytoluene (BHT, primary-anti-oxidant) was dissolved in 18 mL of ethanol (organic solvent). One-half (0.5) mL of Dimethyl Sulfoxide (DMSO, secondary anti-oxidant) and 1 gram of α-Linolenic acid (ALA, organic bio-active molecule) was added to this mixture and magnetically agitated. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (HA-ALA) was dried under vacuum overnight and characterized.

### Example 11

Synthesis of bio-active composite material Hydroxyapatite (10CaO.3P₂O₅.H₂O═Ca₁₀(PO₄)₆(OH)₂, inorganic core) functionalized with all-cis-6,9,12-octadecatrienoic acid (γ-Linolenic acid) (organic bio-active component) in the presence of 2,6-Di-tert-butyl-4-methylphenol (Butylated Hydroxytoluene) and Dimethyl sulfoxide anti-oxidants.

Eight-tenths (0.8) of a gram of Butylated Hydroxytoluene (BHT, primary-anti-oxidant) was dissolved in 18 mL of ethanol (organic solvent). One-half (0.5) mL of Dimethyl Sulfoxide (DMSO, secondary anti-oxidant) and 1 gram of γ-Linolenic acid (GLA, organic bio-active molecule) was added to this mixture and magnetically agitated. Seven (7)mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (HA-GLA) was dried under vacuum overnight and characterized.

### Example 12

Synthesis of bio-active composite material Hydroxyapatite (10CaO.3P₂O₅.H₂O═Ca₁₀(PO₄)₆(OH)₂, inorganic core) functionalized with (5Z, 8Z, 11Z, 14Z, 17Z)-5,8,11,14,17-eicosapentaenoic acid (Eicosapentaenoic acid) (organic bio-active component) in the presence of 2,6-Di-tert-butyl-4-methylphenol (Butylated Hydroxytoluene) and Dimethyl sulfoxide anti-oxidants.

Eight-tenths (0.8) of a gram of Butylated Hydroxytoluene (BHT, primary-anti-oxidant) was dissolved in 18 mL of ethanol (organic solvent). One-half (0.5) mL of Dimethyl Sulfoxide (DMSO, secondary anti-oxidant) and 1 gram of Eicosapentaenoic acid (EPA, organic bio-active molecule) was added to this mixture and magnetically agitated. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (HA-EPA) was dried under vacuum overnight and characterized.

### Example 13

Synthesis of bio-active composite material Dicalcium phosphate (CaO.HPO₃═CaHPO₄, inorganic core) functionalized with N-Acetyl-L-cysteine (organic bio-active component).

Eight-tenths (0.8) of a gram of N-Acetyl-L-cysteine (NAC, organic bio-active molecule) was mixed with 18 mL of ethanol (organic solvent) by magnetic agitation. Seven (7) mL of an aqueous solution of 0.25M Calcium Chloride (CaCl₂)) was added and mixed for 10 minutes. An aqueous solution (7 mL) of 0.15M Trisodium Phosphate was added to this mixture and the resulting mixture was magnetically stirred and transferred to a 40 mL autoclave. The contents of the autoclave were sealed and thermally treated at 85° C. for 8 hours. After cooling the autoclave to room temperature, the bio-active composite material was collected by centrifugation at 4000 rpm and washed three times with 40 mL of ethanol to remove any unreacted precursors. The bio-active composite material (DCPA-NAC) was dried under vacuum overnight and characterized.

Methods Used for the Characterization of the Bio-Active Composite Materials.

Powder X-ray diffraction patterns of bio-active composite materials (Rigaku 2200 D/MAX, 40 mA/40 kV Cu Kα X-ray source) were collected to determine the composition of the inorganic phase. Fourier transform infrared spectroscopy (FTIR, DTGS detector, 1 mg of composite material mixed with 400 mg of KBr, pressed into a pellet) was used to analyze the composition of the inorganic core and organic functional groups. Thermogravimetric analysis (TGA, sample compartment air flow 60 mL/min, 20-1000° C., temperature ramp 10° C./min, sample size 5-10 mg) was performed to determine the relative amount of volatile and organic phase attached to the inorganic core. Confirmation of organic phase composition was achieved through dissolution of the bio-active composite material (HA-OA) in 1M HCl, extracting the bio-active component with ethyl acetate, and subjecting the bio-active component to proton nuclear magnetic resonance analysis (¹H NMR, 600 MHz Bruker Avance II, in deuterated chloroform solvent). To establish that bio-active composite materials can release their organic phase at physiologically relevant conditions, bio-active composite material HA-ALA (1.66 mg in 104 of DMSO) was added to 0.75 mL of phosphate buffered solution at pH 6.6 or 7.4 and agitated at 1000 rpm, 37° C. for 24 hours. Three-quarters (0.75) mL of methanol was added, centrifuged at 14,000 rpm and supernatant collected for high performance liquid chromatography (HPLC, Agilent 1200, isochratic method, mobile phase acetonitrile (90%)-methanol (9.8%)-formic acid (0.1%)-water (0.1%), performed in triplicate). ALA peak was identified based on retention time and quantified utilizing a set of standard solutions of ALA in methanol.

Results.

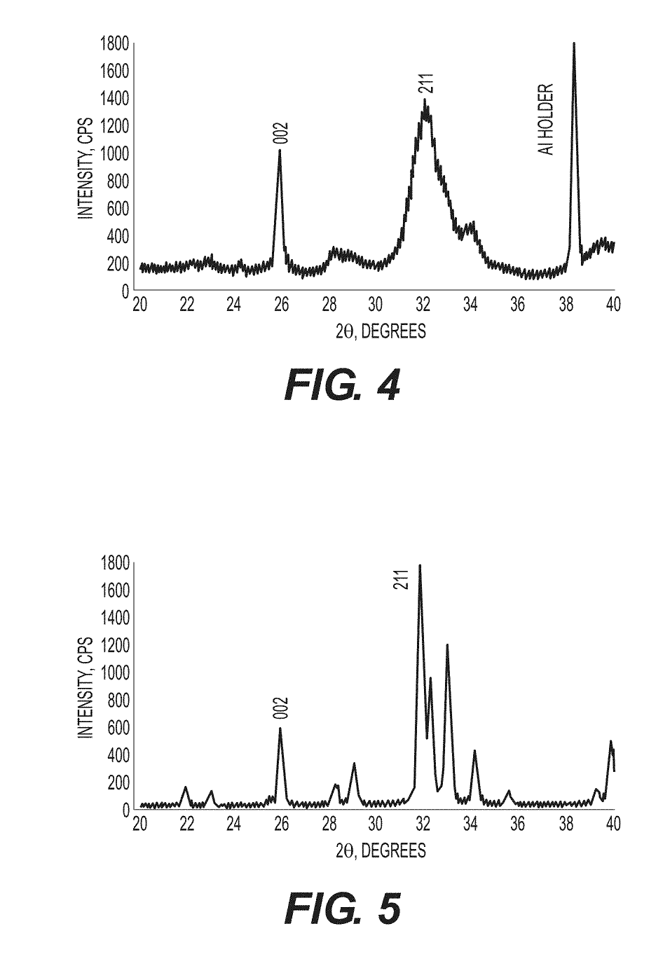

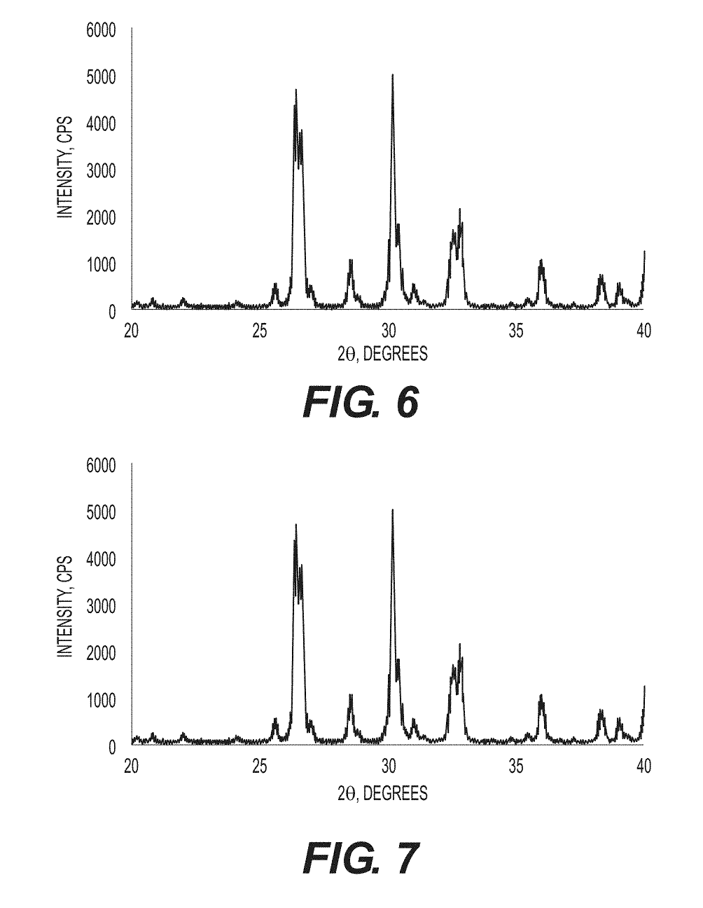

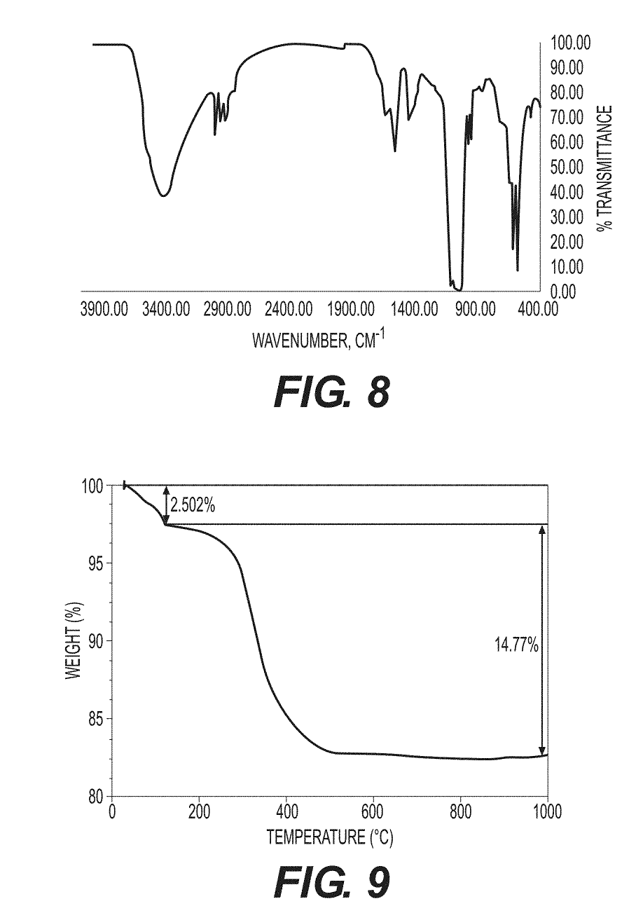

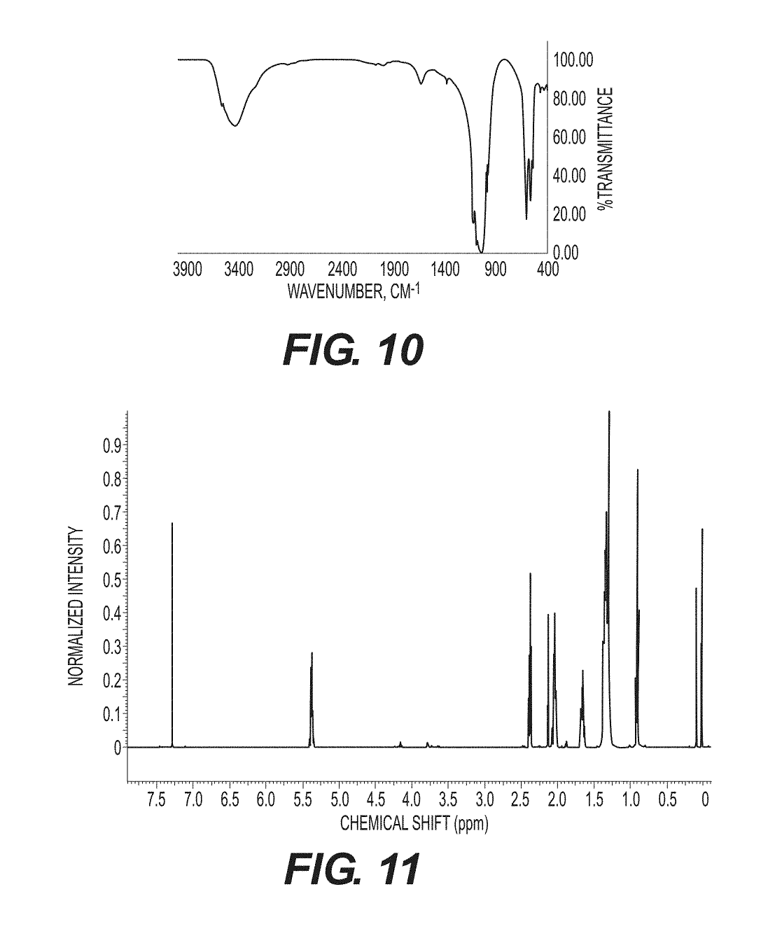

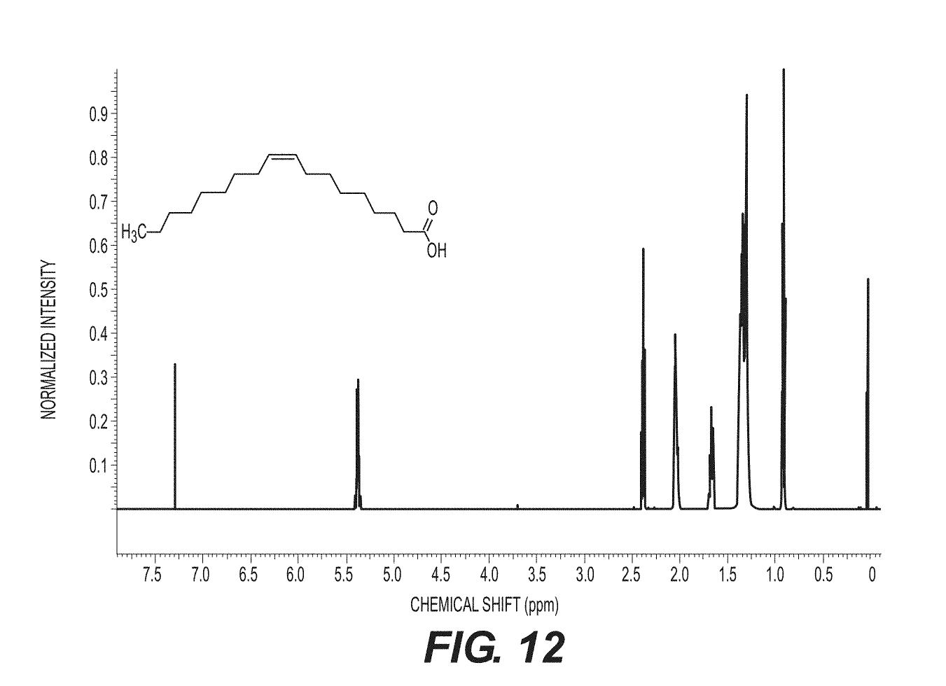

Purity of the inorganic phase of synthesized bio-active composite materials was assessed utilizing XRD analysis. FIG. 4 shows a typical XRD pattern of the synthesized composite materials (disclosed in examples 1-12). Crystalline, phase pure Hydroxyapatite (HA) was the product of hydrothermal reactions at 85° C. after 8 hours. The ratio of the peak intensity of the (0 0 2) reflection to the peak intensity of (2 1 1) reflection line was typically 0.70-0.75. Comparing this to NIST standard reference material (SRM2910b) in FIG. 5 (the ratio is 0.30-0.35) suggests preferential alignment and growth of HA along the (0 0 2) reflection, indicative of the high aspect (length to diameter) ratio particles. In the case of bio-active composite material disclosed in example 13, Dicalcium phosphate was the product of a hydrothermal reaction (FIG. 6). Comparison to commercially available Dicalcium phosphate anhydrous (DCPA, 99% purity, from JT Baker) shown in FIG. 7, indicates that strongly acidic N-Acetyl-L-cysteine drives the preferential formation of DCPA instead of other calcium phosphate phases. Typical FTIR spectra, shown in FIG. 8, of composite materials (disclosed in examples 1-12) corroborates formation of the apatite phase, producing OH (3568 cm⁻¹), PO₄ (1190-920 and 545-625 cm⁻¹), HPO₄/CO₃ (868 cm⁻¹) bands typical of hydroxyapatite. The presence of C═O stretch (1556 cm⁻¹), alkane C—H bend (1490-1360 cm⁻¹), COO ester stretch (1340-1245 cm⁻¹) confirm covalent and non-covalent surface attachment of the organic functional groups to the inorganic core. The intensity of C—H sp2 stretch band of alkene (3012 cm⁻¹) varied depending on the structure of organic functional group and the presence and nature of surfactants and anti-oxidants utilized for each synthesis. However, the presence of the surfactants and anti-oxidants confirms survival of unsaturated C═C double bonds present in all organic molecules used for the synthesis disclosed. A typical thermogram of the bio-active composite materials (FIG. 9), showed possible adsorbed water/solvent loss of 2-4 weight percent before reaching 120° C. Thermal decomposition range of organic molecules functionalized to the composite material was observed in 100-600° C. temperature range. Weight changes observed ranged from 13 to 50 percent, depending strongly on the organic functional group and the presence and nature of surfactants and anti-oxidants utilized for each synthesis. FTIR analysis of the materials after TGA (FIG. 10) shows a pattern typical of crystalline apatite and no presence of the organic phases previously detected. This further confirms that the observed weight loss quantitatively describes organic functionalization of the bio-active composite materials disclosed. Additional confirmation of organic phase composition was achieved through dissolution of the bio-active composite material (HA-OA disclosed in example 1) extracting the bio-active component and subjecting the bio-active component to NMR analysis as described in the materials and methods section above. FIG. 11 shows the NMR spectra of this extract. Comparing the spectra of this extract to the NMR spectra of the starting organic precursor Oleic acid (FIG. 12) confirms that the bio-active materials are being functionalized with the intended organic molecule. Additional peaks observed in the NMR of the extract possibly are due to the presence of ethyl acetate and other solvents used during the process. Release of the bio-active organic molecule α-Linolenic acid from bio-active composite material HA-ALA (disclosed in example 10) was confirmed via HPLC analysis as described in the materials and methods section above. A phosphate buffered solution at pH 6.6 contained 0.283±0.013 mg/mL (n=3) of α-Linolenic acid after a 24-hour exposure to HA-ALA composite material. Similarly, a phosphate buffered solution at pH 7.4 contained 0.284±0.026 mg/mL (n=3) of α-Linolenic acid after a 24-hour exposure to HA-ALA composite material.

### Experimental Series 2: Effectiveness of Bio-Active Composite Material (Anti-Inflammatory Properties)

Materials and Methods.

All chemicals, unless otherwise indicated, were procured from Sigma-Aldrich and used without additional purification. Stock solutions of Docosahexaenoic acid (DHA) in Dimethyl Sulfoxide (DMSO), Aspirin in physiologically buffered saline (PBS, pH 7.4) were prepared prior to their use. E. Coli derived Lipopolysaccharide (LPS) was reconstituted at 1 ug/mL, sterile filtered, and stored at −80 C until needed. RAW 264.7 murine macrophage cell line was obtained from ATCC (Manassas, Va.). Cells were thawed at passage 5 or 6 and were maintained in DMEM complete growth media supplemented with 10% FBS (Hyclone, GE Healthcare)+1% Penn/strep (Gibco) until needed. Peripheral blood derived primary human CD14+monocytes (BioreclamationlVT, Albany, N.Y.) were also maintained in DMEM growth media until needed. Prior to experimentation, monocytes were differentiated to macrophages by using macrophage colony stimulating factor (M-CSF) at 25 ng/mL in media for up to three days or until cells had reached near confluence (˜95%). RAW 264.7 cells were seeded at roughly 5,000 cells per well in a 96-well plate and allowed to grow to near confluence. At confluence, cells were pre-treated with LPS for 2 hours. At the 2-hour mark, cells were treated with DMEM media containing DMSO (1% w/w, negative control), Aspirin (positive control, 10 nmol/L), DHA (100 umol/L) or a combination of the two. Bio-active composite material Hydroxyapatite-Docosahexaenoic acid (HA-DHA) was dispersed in DMSO and delivered at similar concentrations as DHA alone (described above). Cells were harvested at 2, 4, and 6 hours after LPS stimulation. Human CD14+ cells were seeded at roughly 3.3*10⁴ cells per well in a 96-well plate and treated with MCSF until full confluence. Cells were treated with LPS for 2 hours, at which time they were exposed to the same treatments described above for RAW 264.7 cells. Cells were harvested at 4 and 6 hours. All tests were performed in triplicate.

Following each treatment, sample media was tested for inflammatory tumor necrosis factor alpha (TNF-alpha) expression using a commercially available sandwich ELISA kits designed for either mouse or human cells (R&D Systems). Samples showing reduction in TNF-alpha were further analyzed using the Resolvin D1 and Resolvin D2 ELISA kits (Cayman Chemical). Mean and standard deviations were calculated for each analyte. ELISA results were normalized to the total protein readings of each well. All experiments were performed in triplicate.

Statistical Analysis—Mean and standard deviation were obtained from an n of at least 3 biologic and technical replicates. One way Analysis of Variance (ANOVA) was performed on the samples following a Bonferroni post-hoc test, which compared each treatment to controls and to each other to determine statistical significance. Differences in significance are denoted by the following: *p<0.05, **p<0.01, ***p<0.001

Results.

One major cell signaling protein (cytokine) of the acute phase reaction involved in inflammation and released by microphages stimulated with LPS is TNF-alpha (Tjomme van der Bruggen et al., Lipopolysaccharide-Induced Tumor Necrosis Factor Alpha Production by Human Monocytes Involves the Raf-1/MEK1-MEK2/ERK1-ERK2 Pathway. Infection and Immunity, 1999, p. 3824-3829). In FIG. 13, RAW 264.7 murine microphages were stimulated with 100 ng/ml of LPS over a 6-hour treatment (Tx) time. FIG. 13 shows the cumulative TNF-alpha expression was reduced from 30.8 (±5.8) pg/ug protein in DMSO control samples to 24.7 (±4.5) pg/ug protein with DHA+Aspirin, which corresponds to a near 20% reduction in overall expression. More striking, co-treatment with bio-active composite material HA-DHA and Aspirin (HA-DHA+Aspirin) reduced expression to 20.3 (±3.9) pg/ug protein, corresponding to a 34.9% reduction in TNF-alpha expression relative to the DMSO control.

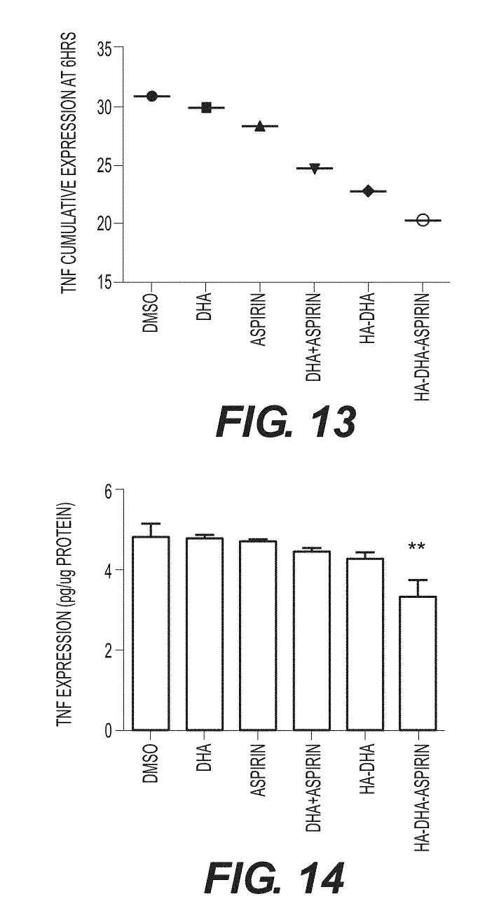

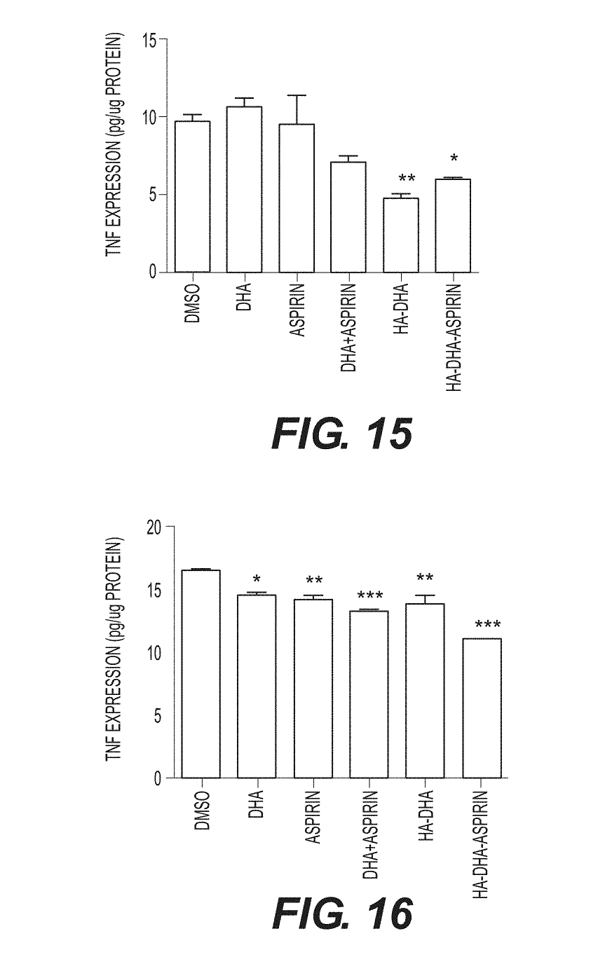

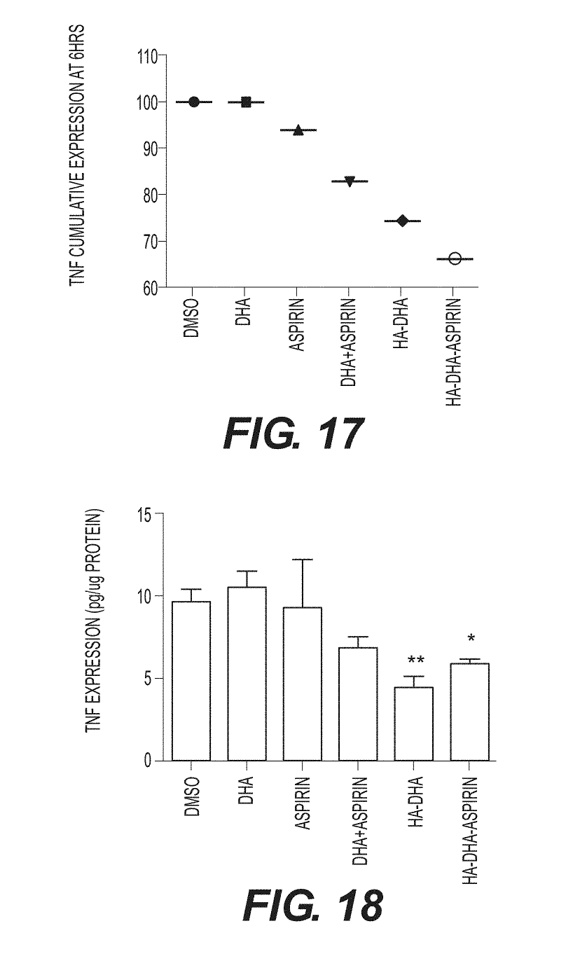

Looking at 2 hrs LPS+2 hrs treatment time (Tx) points (FIG. 14), no early therapeutic treatment except DHA-HA+Aspirin elicited a statistically significant (p<0.01) decrease (3.37pg/ug±0.7) in TNF expression compared to controls, including DMSO null treatment control (4.8 pg/ug±0.6) and DHA+Aspirin positive (anti-inflammatory) control (4.4 pg/ug±0.4). At 2 hrs LPS+4 hr Tx (FIG. 15), the results show that both HA-DHA (4.7 pg/ug±0.5) and HA-DHA+Aspirin (5.9 pg/ug±0.2) statistically reduced (p<0.01 and p<0.05, respectively) TNF expression compared to DMSO control (9.6 pg/ug±0.7), DHA+Aspirin (7.03 pg/ug±0.7) and all other treatments. Looking at the later time point 2 hr LPS+6 hr Tx (FIG. 16), the results show that all treatments statistically (p<0.05) reduced TNF compared to DMSO (16.4 pg/ug±0.2) control. Interestingly, HA-DHA+Aspirin reduced the expression of TNF most dramatically to 11.2 pg/ug±0.03), a 32% reduction relative to DMSO control.

Together, these data show that in murine macrophages, relative to positive controls DHA and Aspirin, HA-DHA and HA-DHA+Aspirin treatments significantly reduced TNF-alpha expression cumulatively and at various time points.

The results in FIG. 17 show that in human CD14+ cells, DHA+Aspirin, HA-DHA and HA-DHA+Aspirin also significantly reduced cumulative TNF expression over a 6-hour treatment time (between 20-40%) compared to DMSO, DHA only and Aspirin controls. Looking at individual time points (2 hr LPS+4 hr Tx) in FIG. 18, the data show that only HA-DHA (4.6pg/ug±0.6) and HA-DHA+Aspirin (5.9pg/ug±0.3) exhibited statistically significant (p<0.01 and p<0.05, respectively) reductions in TNF-alpha expression compared to DMSO control (9.6pg/ug±0.8). Table 1 shows the mean and standard deviations for all experimental groups from the 2 hr+4 hr treatment time for TNF expression.

TABLE 1

| Treatment | Mean | Std Dev |
|---|---|---|
| DMSO | 9.6 | 0.8 |
| DHA | 10.5 | 1 |
| Aspirin | 9.1 | 2.9 |
| DHA + Aspirin | 6.9 | 0.6 |
| HA-DHA | 4.6 | 0.6 |
| HA-DHA + Aspirin | 5.9 | 0.3 |

A number of scientific reports have shown formation of chemical mediators derived from polyunsaturated fatty acids (such as Docosahexaenoic acid) that control the inflammatory response by activating local resolution programs. These specialized pro-resolving mediators (lipoxins, resolvins, protectins, maresins) are enzymatically biosynthesized during the resolution of self-limited inflammation.

### REFERENCES

Serhan C N. (2010) The American Journal of Pathology, Vol. 177, No. 4.
Spite M, Serhan C N. (2010) Circ Res., 107(10): 1170-1184.
Sungwhan F. Oh et al. (2011) The Journal of Clinical Investigation, Volume 121 Number 2.
Recchiutti A, Serhan C N (2012) Frontiers in Immunology, Volume 3, Article 298.

To investigate further the anti-inflammatory effects the inventors observed in both human and murine macrophages challenged with pathogenic LPS and to determine if the bio-active composite material HA-DHA on its' own and in combination with Aspirin induces formation of pro-resolution mediators, the inventors measured Resolvin production secreted from challenged human macrophages.

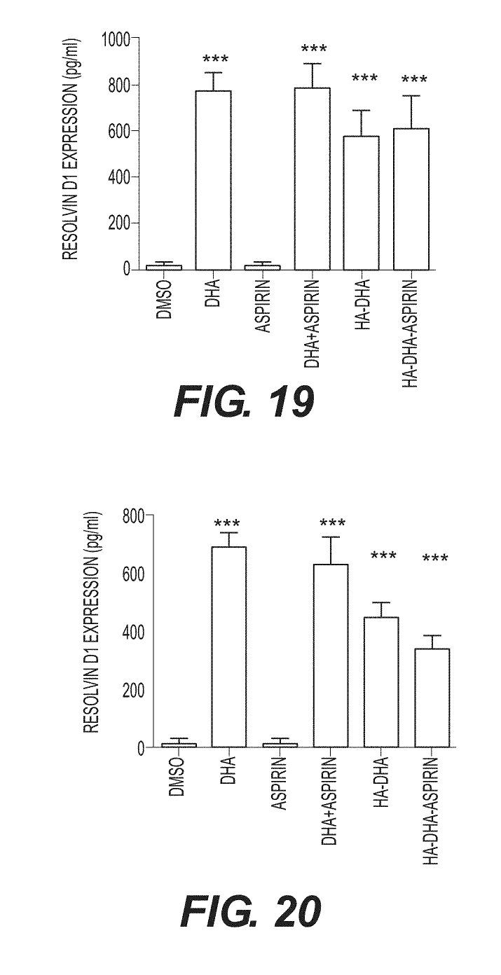

As shown in FIG. 19, both positive controls (DHA and DHA+Aspirin) and bio-active composite material HA-DHA alone and co-treated with Aspirin (HA-DHA+Aspirin) statistically (p<0.001) increased Resolvin D1 (RvD1) expression and release compared to DMSO and Aspirin only controls. The mean and standard deviation for these treatments are given in Table 2 for this time point. Looking at 2-hour+6-hour Tx in FIG. 20, a similar induction was measured by the same DHA-containing groups and at the same level of significance as in the earlier time point. Values from all treatment groups can be observed in Table 3.

TABLE 2

| Treatment | Mean | Std Dev |
|---|---|---|
| DMSO | 19.5925706 | 11.34835654 |
| DHA | 771.1076535 | 87.9994607 |
| Aspirin | 18.8652094 | 11.45659293 |
| DHA + Aspirin | 794.4977729 | 105.7844223 |
| HA-DHA | 577.3004706 | 110.1933794 |
| HA-DHA + Aspirin | 610.0345187 | 159.2078307 |

TABLE 3

| Treatment | Mean | Std Dev |
|---|---|---|
| DMSO | 16.72470053 | 5.22570403 |
| DHA | 678.0297282 | 50.17032815 |
| Aspirin | 16.95541449 | 10.88641452 |
| DHA + Aspirin | 635.2403234 | 91.05379486 |
| HA-DHA | 447.1837963 | 49.96510757 |
| HA-DHA + Aspirin | 342.2245152 | 42.01188006 |

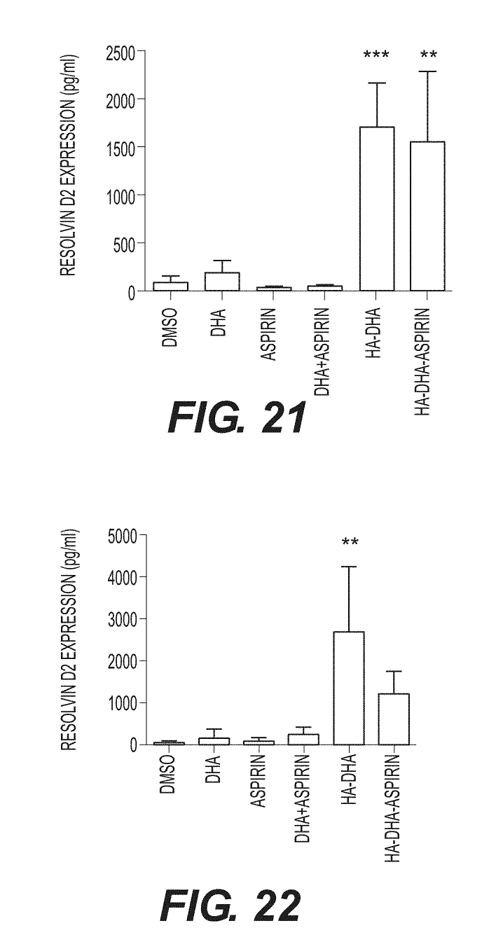

Next, another resolvin (Resolvin D2, RvD2), was investigated relative to our treatments. As FIG. 21 (2 hour LPS+4 hr Tx) shows, unlike RvD1, HA-DHA and HA-DHA+Aspirin were the only treatment groups to significantly (p<0.001 and p<0.01, respectively) up-regulate RvD2 expression. All values including mean and standard deviation are included for this time point in Table 4. Looking at RvD2 expression following 6 hours of therapeutic treatment and 2 hours of LPS stimulation, FIG. 22 shows that only bio-active composite material HA-DHA treatment resulted in a statistically significant (p<0.01) increase of RvD2 expression and release relative to all other treatment groups. However, it is important to note that HA-DHA+Aspirin co-treatment was trending toward significance. All values from this time point can be observed in Table 5.

TABLE 4

| Treatment | Mean | Std Dev |
|---|---|---|
| DMSO | 89.57212793 | 67.9490549 |
| DHA | 194.2080195 | 125.8953116 |
| Aspirin | 25.0166105 | 21.51516845 |
| DHA + Aspirin | 53.56970532 | 21.78397616 |
| HA-DHA | 1695.568894 | 475.1134125 |
| HA-DHA + Aspirin | 1551.359628 | 732.9133413 |

TABLE 5

| Treatment | Mean | Std Dev |
|---|---|---|
| DMSO | 11.9751382 | 10.88470294 |
| DHA | 161.9360483 | 180.3155729 |
| Aspirin | 73.2478587 | 73.7846235 |
| DHA + Aspirin | 234.8734436 | 174.797275 |
| HA-DHA | 2696.161212 | 1407.579268 |
| HA-DHA + Aspirin | 1203.523588 | 488.0046549 |

In conclusion, these results show that in two cell cultures from two different species, bio-active composite material HA-DHA alone and in combination with Aspirin promotes anti-inflammatory effects through reduction of cytokine expression (TNF-alpha) and increased expression of pro-resolution mediators (RvD1 and RvD2). Additionally, the bio-active composite material HA-DHA showed similar or better effects to its' bio-active component DHA.

### Experimental Series 3: Effectiveness of Bio-Active Composite Materials (Anti-Microbial Properties)

Materials and Methods.

Streptococcus mutans UA157 (ATCC) was used for all experiments. Frozen cells were plated on 100 mm Brain Heart Infusion (BHI) agar plates. After overnight incubation (37° C. and 5% CO₂ atmosphere), a single colony was inoculated in 3 mL Brain Heart Infusion (BHI) liquid media. A 400 uL culture was grown overnight and then diluted to 40 mL with fresh BHI media, and 3.96 mL of bacterial culture was placed in 50 mL tissue culture flasks (three flasks per experimental condition). DMSO (40 uL, Sigma-Aldrich) was added to each test tube alone (control) or containing HA-OA, HA-DHA, HA-EPA, HA-ALA, or HA-GLA (resulting in final bio-active composite material concentration of 1.66 mg/mL). The bacterial culture was placed in a 37° C., 5% CO₂ incubator and on a laboratory rocking platform at 10 rpm. Samples (10 uL) were taken at predetermined time points (0, 2, 4, 6, and 24 hours) and serial dilutions were performed so that each sample will result in 30-200 colonies (for practical and accurate counting purposes). Diluted samples were plated on BHI agar plates and incubated for 24 hours. BHI agar plates were digitized by a stereoptical light microscope (Leica MZ16) and the captured images were used to quantify Colony Forming Unit (CFU) for each sample by ImageJ (NIH) software. For reduced initial inoculation experiments, 0.4 uL overnight culture was used (compared to 400 uL) in 40 mL fresh BHI liquid media to confirm bactericidal and bacteriostatic effects. Standard O'Toole-Kolter biofilm quantification protocol was used to quantify biofilm formation in the presence of DMSO (control), HA-OA, HA-DHA, HA-EPA, HA-ALA, or HA-GLA (final bio-active composite material concentration of 1.66 mg/mL). Overnight, S. mutans liquid culture was inoculated in Biofilm Formation (BF) media (25% TSB+5 mg/mL yeast extract+30 mM sucrose). S. mutans were allowed to attach to a 9.6 cm² 6-well tissue culture plate containing a bio-active composite material to be tested for 3 hours. Unattached cells, bio-active composite materials, and media were removed and the plates were washed with phosphate-buffered saline (PBS) three times. Fresh BF media were added and S. mutans were allowed to grow for additional 3h. After a 6-hour attachment/incubation, media were removed and the plates were washed with de-ionized water twice. Crystal violet (2 mL, 0.1% w/w) solution was added and stained the attached cells for 15 minutes. Dye was removed and the petri dishes were washed with de-ionized water twice. The plates were dried in a biological safety cabinet overnight. Acetic acid (2 mL, 30% v/v) was added and incubated at room temperature for 15 minutes. One-hundred twenty-five (125) uL of the solubilized crystal violet solution was transferred to a 96 well plate (Olympus) and absorbance of collected solutions was measured at 550 nm (SpectraMax plate reader, Molecular Devices).

Results.

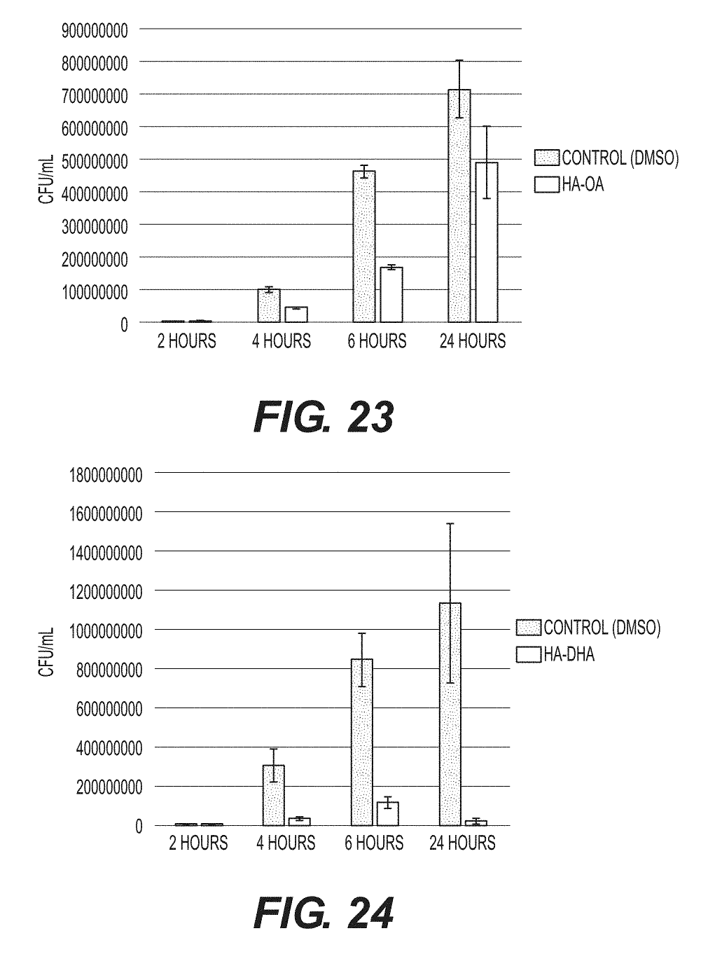

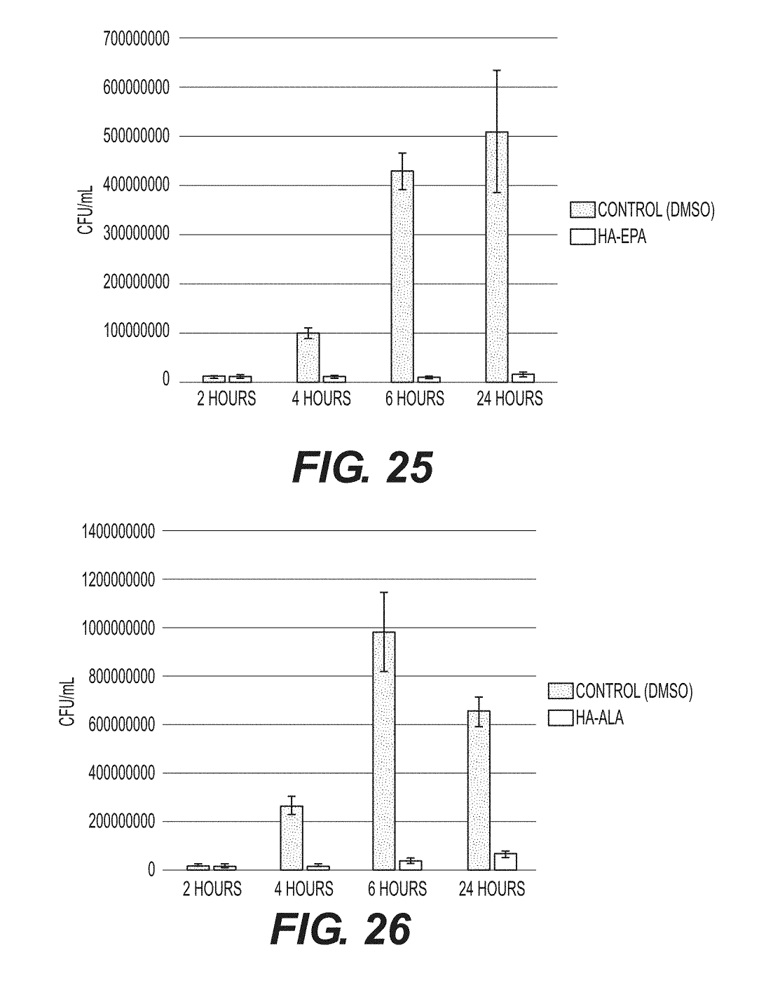

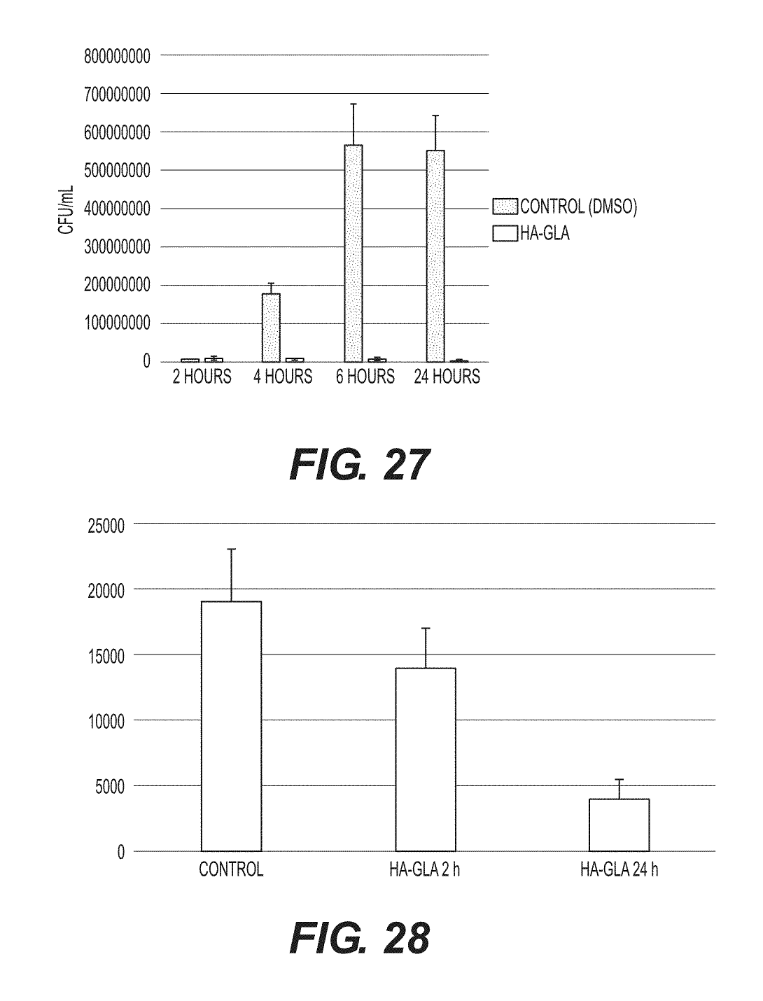

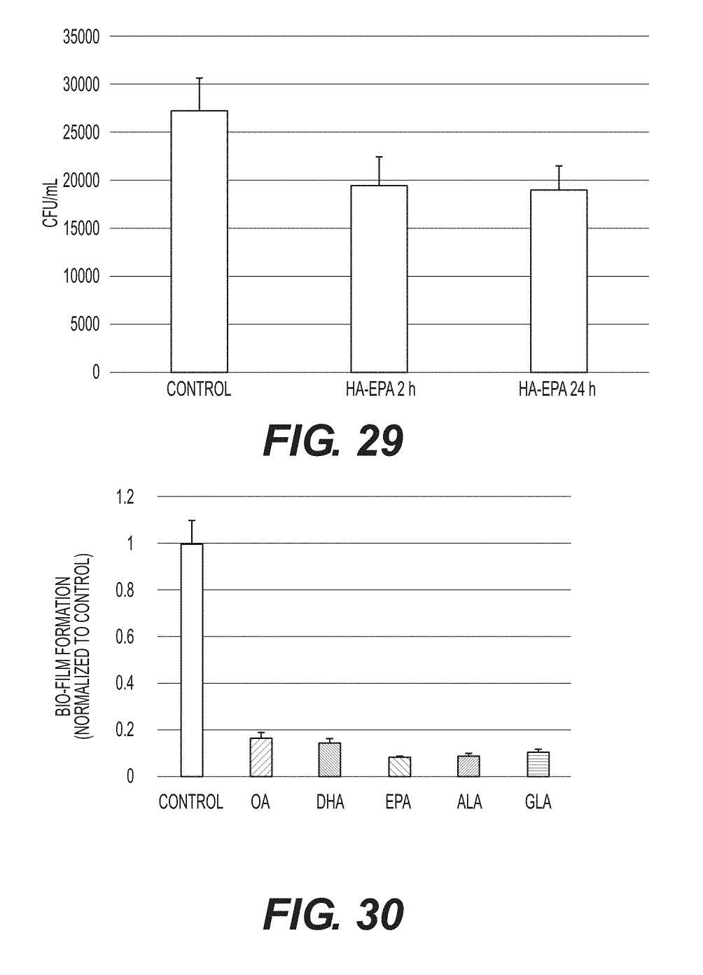

Streptococcus mutans (S. mutans) is a Gram-positive bacterium that metabolizes carbohydrates and produces lactic acid as a by-product. This process creates an acidic environment that interacts with bio-active composite materials (HA-FA) by dissolving the inorganic core (Hydroxyapatite, HA) and hydrolyzing the covalent bond between the inorganic core (HA) and organic bio-active molecules attached (fatty acids, FA). Bio-active composite materials (HA-OA, HA-DHA, HA-EPA, HA-ALA and HA-GLA) functionalized with unsaturated fatty acids Oleic acid (OA), Docosahexaenoic acid (DHA), Eicosapentaenoic acid (EPA), alpha-Linolenic acid (ALA) and gamma-Linolenic acid (GLA) (disclosed in examples 1-12) were tested. Quantification of Bacterial Colony Forming Unit per mL (CFU/mL) for control group (DMSO only) vs. experimental group (bio-active composite material treatments) is shown in FIG. 23 (control vs. HA-OA), FIG. 24 (control vs. HA-DHA), FIG. 25 (control vs. HA-EPA), FIG. 26 (control vs. HA-ALA), FIG. 27 (control vs. HA-GLA) at 2-, 4-, 6-, and 24-hour time points. All bio-active composite materials treatments inhibited planktonic S. mutans growth at 4 hours, 6 hours, and 24 h, however with varying effectiveness. Results from the HA-OA experiment show HA-OA inhibits S. mutans most effectively at the hour 6 time point (control=4.65±1.91×10⁸: HA-OA=1.71±0.66×10⁸; p<0.001). However, S. mutans continue to grow with HA-OA treatment (FIG. 23). Thus, HA-OA is minimally bacteriostatic against S. mutans. Results from HA-DHA treatment show that this treatment inhibits S. mutans most effectively at hour 24 (control=1.13±0.40×10⁹; HA-DHA=2.72±1.73×10⁷; p<0.001). HA-DHA is bacteriostatic at 4 and 6 hours, but reaches a bactericidal level by hour 24 (FIG. 24). Results from the HA-EPA experiment show S. mutans is effectively inhibited at 4, 6, and 24 hours, and does not lead to significant growth over the 24-hour period (1.23±0.19×10⁷, 1.19±0.21×10⁷, 1.01±0.12×10⁷, 1.59±0.39×10⁷, respectively). Thus, HA-EPA is effectively bacteriostatic at 4, 6, and 24 hours (p<0.001 compared to DMSO control) (FIG. 25). Results from the HA-ALA experiment also show that this treatment inhibits S. mutans compared to control. CFU/mL of HA-ALA treated samples at 2, 4, 6 and 24-hour time points are 9.40±2.5×10⁶, 1.79±0.29×10⁷, 3.74±0.90×10⁷, and 6.36±1.32×10⁷, respectively (p >0.05) (FIG. 26). Thus, HA-ALA is bacteriostatic at 4, 6, and 24 hours. HA-GLA inhibits S. mutans most effectively among the bio-active composite materials tested (bactericidal at 4 hours (p<0.001), 6 hours (p<0.001), and 24 hours (p<0.001)) (FIG. 27). Results of reduced initial inoculation experiment confirm HA-GLA is bactericidal at 24 hours (FIG. 28) and HA-EPA is bacteriostatic at 24 hours (FIG. 29). A 24-hour HA-GLA treatment produced a reduction of 79.1±32.6% in CFU/mL of S. mutans relative to control (p=<0.001). A 2-hour HA-GLA treatment reduced CFU/mL of S. mutans by 26.8±8.2% relative to control (p=0.002). A 24-hour HA-EPA treatment reduced CFU/mL of S. mutans by 30.5±5.4% relative to control (p=<0.001). A 2-hour HA-EPA treatment reduced 28.7±5.6% in CFU/mL of S. mutans relative to control (p<0.001). Results of a biofilm assay (FIG. 30) show that bio-active composite materials HA-OA, HA-DHA, HA-EPA, HA-ALA, HA-GLA inhibit biofilm formation (83±2%, 85±2%, 91±0.3%, 90±0.8%, and 89±1% reduction, respectively, relative to DMSO control) during the 6h incubation (p<0.001). Although only S. mutans was used to test antimicrobial activities here, unsaturated and saturated fatty acids have been shown to have antimicrobial properties against a wide range of pathogenic microorganisms, including methicillin-resistant Staphylococcus aureus (Farrington M N et al. J Med. Microbiol., 36, 56-60 (1992)), Helicobacter pylori (Hazel et al. J Clin Microbiol., 28, 1060-1061 (1990)), and oral disease related pathogens such as Streptococcus mutans, Porphyromonas gingivalis, Candida Albicans, Aggregatibacter segnis, Aggregatibacter actinomy cetemcomitans, Fusobacterium nucleatum subsp. polymorphum, and Prevotella intermedia (Jae-Suk Choi et al., Journal of Environmental Biology, vol. 34, 673-676, (2013)). These reports in combination with demonstrated effectiveness of the herein-disclosed bio-active composite materials to inhibit growth of pathogenic S. mutans and their biofilm through release of bio-active organic fatty acids indicate that these materials will be effective against a wide range of pathogenic microorganisms.

### Experimental Series 4: Effectiveness of Bio-Active Composite Material (Biomineralization Properties)

Materials and Methods.

Primary human dental pulp tissues were isolated from third molar teeth recently extracted. Pulp cells were grown from excised tissue sections (1 cm×1 cm) in T25 flasks (Corning). The cells were grown in Dulbecco's Modified Eagle's Medium (DMEM) supplemented with 10% fetal bovine serum and 5% Penicillin/streptomycin (Gibco) at 37° C. and 5% CO₂. Human fetal osteoblasts -hFOB1.19 (ATCC®CRL-11372) were grown in 1:1 mixture of Ham's F12 Medium Dulbecco's Modified Eagle's Medium with 2.5 mM of L-glutamine (without phenol red) supplemented with 10% fetal bovine serum, 0.3 mg/mL G418/Geneticin (Sigma) and 5% Penicillin/streptomycin at 34° C. and 5% CO₂. Upon reaching 80% confluence, the cells were detached from the surface of the flasks by using 0.25% Trypsin (Gibco), collected, stained with Trypan Blue (Gibco) and counted). For the mineralization experiments, 5×10⁴ cells were seeded on the well surfaces. Surfaces uncoated (2D cultures) or coated with extracellular matrix substrate (for 3D cultures) were used to culture the cells with the growth medium in the eight-well chambered cover glass (Lab-Tek™). After 24 hours of incubation, the growth medium was replaced with a fresh growth medium containing the HA-DHA or HA-ALA dissolved in DMSO (Sigma) and diluted to final concentrations of 0.1 and 0.25 mM. HA-DHA and HA-ALA were pipetted at least 10 times before being added to the medium to eliminate aggregates. As a positive control, cells were incubated with the calcifying medium, which is a growth medium supplemented with 10 mM β-glycerophosphate, 100 μM L-ascorbic acid 2-phosphate and 10⁻⁸ mM dexamethasone (Sigma). As a negative control, cells were cultured with the growth medium without any supplements or particles of bioactive composite materials. The growth medium was replaced every three days, and after incubating the dental pulp cells for 14 days and hFOB1.19 cells for 11 days, the media was disposed, and the cells were fixed with 4% paraformaldehyde for 20 minutes at room temperature. The fixed cells were washed with distilled water and stained with 1,2-dihydroxyanthraquinone-Alizarin Red S (Sigma) for 30 minutes followed by four washes with distilled water. The stained cultures were analyzed under the Nikon Eclipse Ti-U inverted phase contrast fluorescent microscope (Nikon) by using the 16.25-megapixel CMOS color camera DS-Ri2 (Nikon). Phase contrast images were taken using the NIS-Elements software version 3.0 (Nikon), and light intensity of the cell cultures and mineralized areas were quantified using the image processing program ImageJ V.1.48 (NIH). Alkaline phosphatase activity was determined by using the Alkaline Phosphatase detection kit (Millipore). Following the manufacturer recommended protocol, cells were fixed for 3 minutes and then washed once with rinse buffer TBST (Sigma) followed by incubation with Fast Red Violet solution:Napthol AS-BI phosphate solution in AMPD buffer:distilled water in a ratio of 2:1:1 for 30 minutes. After a second wash with the buffer, the cells were analyzed under the microscope. Dental pulp stem cells were characterized immunocytochemically (ICC). The pulp stem cells were blocked with 10% normal donkey serum (GeneTex) for an hour and then permeabilized by incubation with 0.3% Triton X-100 (Promega) for an additional hour. The treated cells were incubated with rat anti-human OCT4 (Octamer-binding transcription factor 4), mouse anti-human CD 105 and mouse anti-human SOX2 ((sex determining region Y)-box 2) primary antibodies (R&D Systems) overnight at 4° C. Cells were washed twice and incubated with 1:100 dilution of donkey anti-rat or anti-mouse Immunoglobulin G NorthernLights™ NL557-conjugated polyclonal secondary antibodies (R&D Systems) for 3 hours at room temperature. After washing, the cells were incubated with 10 mM of 4′,6-diamidino-2-phenylindole—DAPI (Molecular Probes) for 30 minutes at room temperature to stain the nucleus. The cells were washed again and analyzed under Zeiss Axiovert A1 inverted fluorescence microscope (Carl Zeiss) equipped with an AxioCam MRm CCD camera and a LED excitation light source (Thorlabs). Fluorescence photos were taken using the Zen 2 software (Carl Zeiss). Three replicates per each treatment were analyzed and 10 photos were collected from each replicate. Light and fluorescence intensities were expressed as mean value±one standard deviation of at least three separate experiments performed in triplicate and included positive and negative controls for comparison. Statistical comparisons were performed using one-way analysis of variance (ANOVA) followed by a two-tailed Student's t-test. Results were considered statistically significant when p≤0.05.

Results.

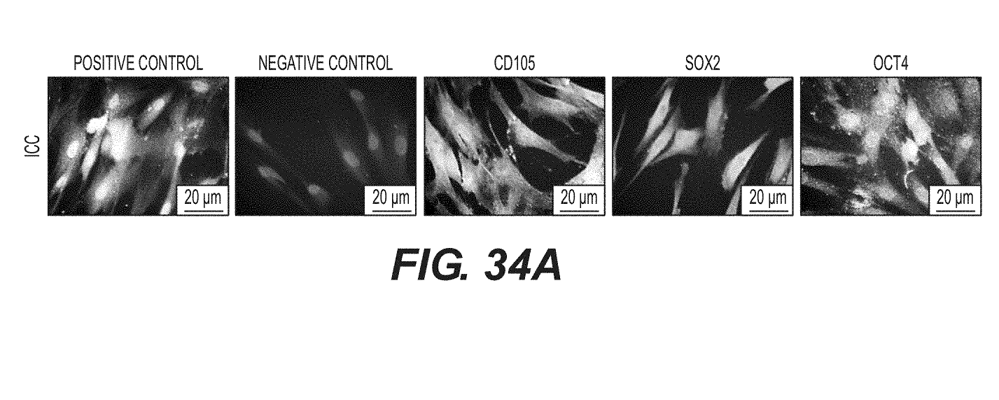

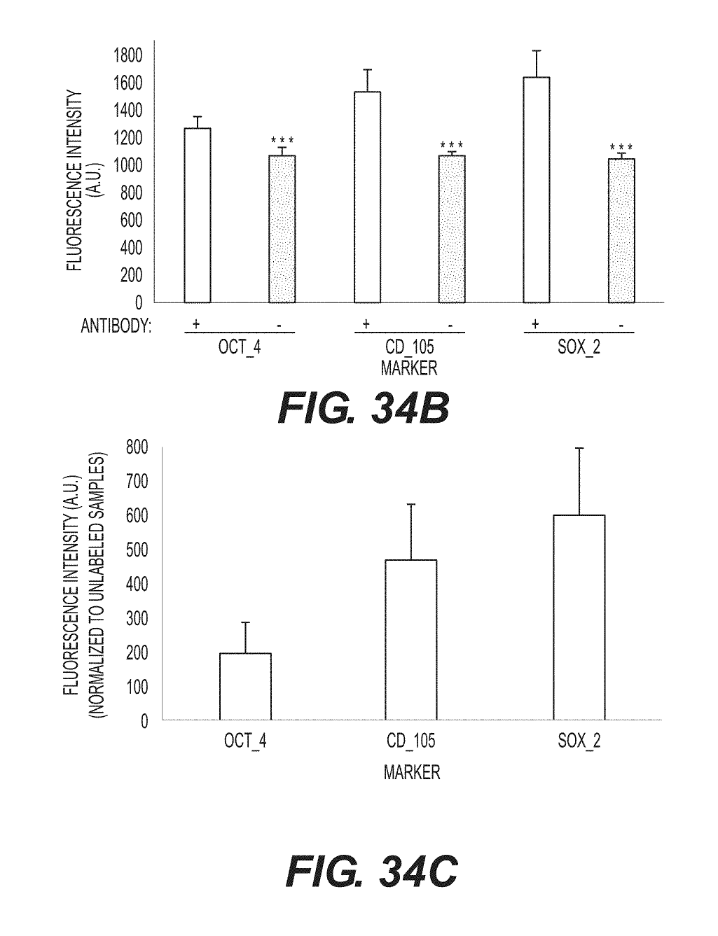

Prior to mineralization experiments, the primary dental pulp cells were characterized immunocytochemically (ICC) by quantification of pluripotent stem cell markers OCT4, SOX2 and mesenchymal stem cell marker CD105 proteins via ligation with specific binding antibodies. FIG. 34A shows observed expression of these cell markers. Relative to Cells ligated with the antibody for the housekeeping gene Glyceraldehyde-3-phosphate dehydrogenase (GAPDH) used as a POISITIVE CONTROL and non-ligated cells used as a NEGATIVE CONTROL, the fluorescence intensity of all markers analyzed was significantly higher (*** denotes for p≤001). The intensity of OCT4, CD105 and SOX2 antibody labeled cells was 1257.52±89.51, 1521.72±160.62 and 1626.94±196.84 Arbitrary Units (AU), respectively (FIG. 34B). Relative to the non-ligated NEGATIVE CONTROL cells, this constitutes an increase of 198.34±89.15 (OCT4), 470.05±160.62 (CD105) and 598.28±196.84 AU (FIG. 34C). Since the primary dental pulp cells characterized contain a population of cells that express pluripotent stem cell markers, the inventors assessed the ability of HA-ALA and HA-DHA to induce differentiation in undifferentiated stem cells (osteoinductive properties) and mineral formation and deposition (osteoconductive properties).

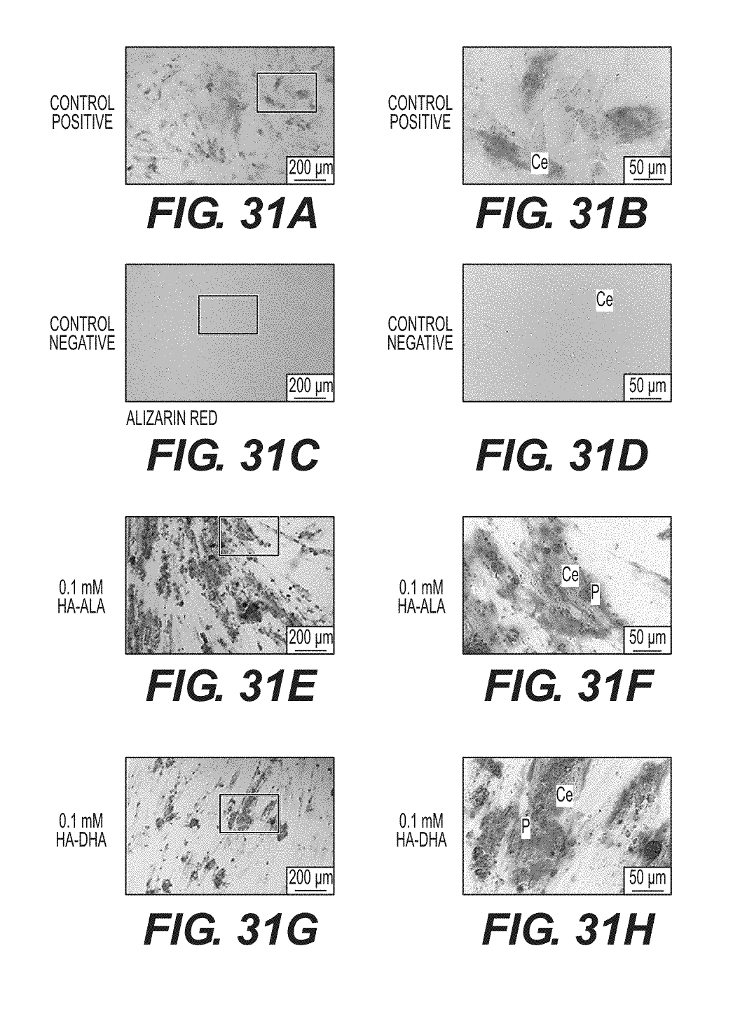

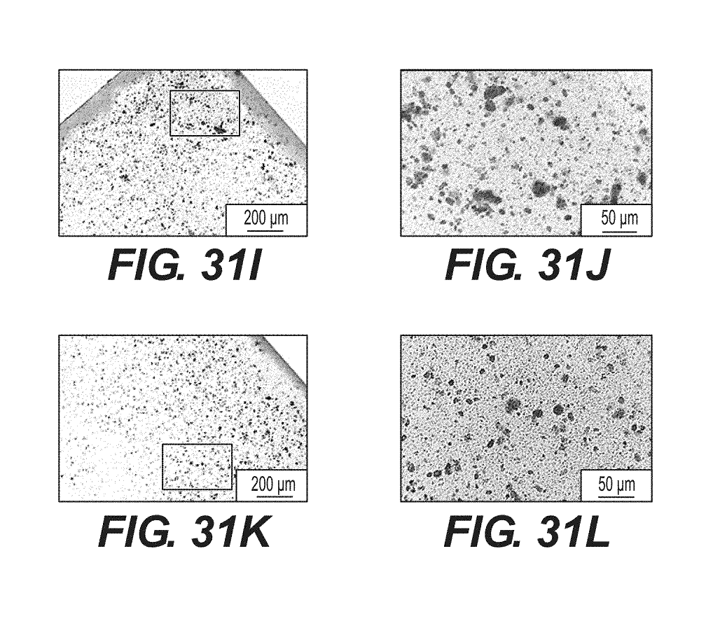

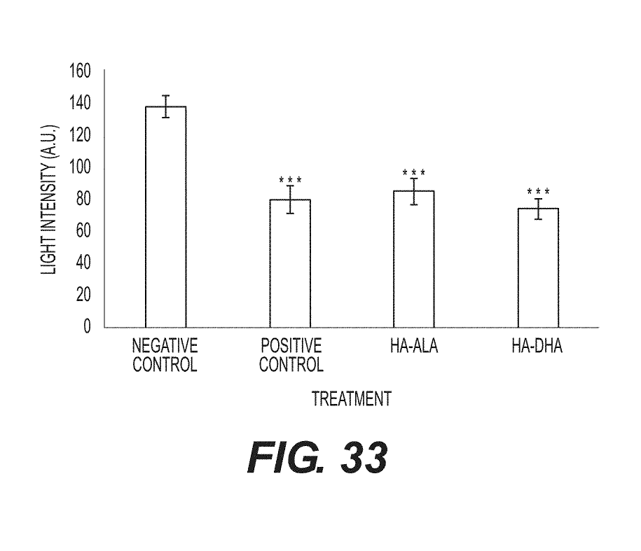

Incubation of characterized human primary dental pulp cells with lower concentration (0.1 mM) of bio-active composite materials HA-ALA and HA-DHA demonstrated mineral formation and deposition on the cell surface in 2D cultures stained with Alizarin Red S reagent. Both bio-active composite materials adhered and accumulated on the mineralizing cells (Ce) and appear as small circular dark particles (P) in FIGS. 31E-F and 31G-H, respectively. FIGS. 31F and 31H are magnifications of the boxed areas in FIGS. 31E and 31G, respectively. Mineralization (depicted as light grey stained areas in FIGS. 31A-L) was also observed in cells exposed to the calcifying medium (FIGS. 31A-B; FIG. 31B is a magnification of the boxed area in FIG. 31A). Cells which were not exposed to the bioactive materials or calcifying medium showed growth without mineralizing (FIGS. 31C-D; FIG. 31D is a magnification of the boxed areas in FIG. 31C). Bio-active materials exposed to culture medium without cells (FIGS. 31I-L; FIG. 31L is a magnification of the boxed areas in FIG. 311) arbitrarily spread as individual particles. Quantified light intensity values signifying absorption by the mineral formed in cultures were highest for non-mineralizing cells 136.96±6.42 AU, while mineralizing cells exposed to calcifying medium (POSITIVE CONTROL) or HA-ALA or HA-DHA exhibited a significant decrease (p≤0.001) of more than 52 AU in light intensity measured compared to the NEGATIVE CONTROL (79.34±8.43, 84.66±7.90 and 73.87±5.76 AU, respectively) (FIG. 33).

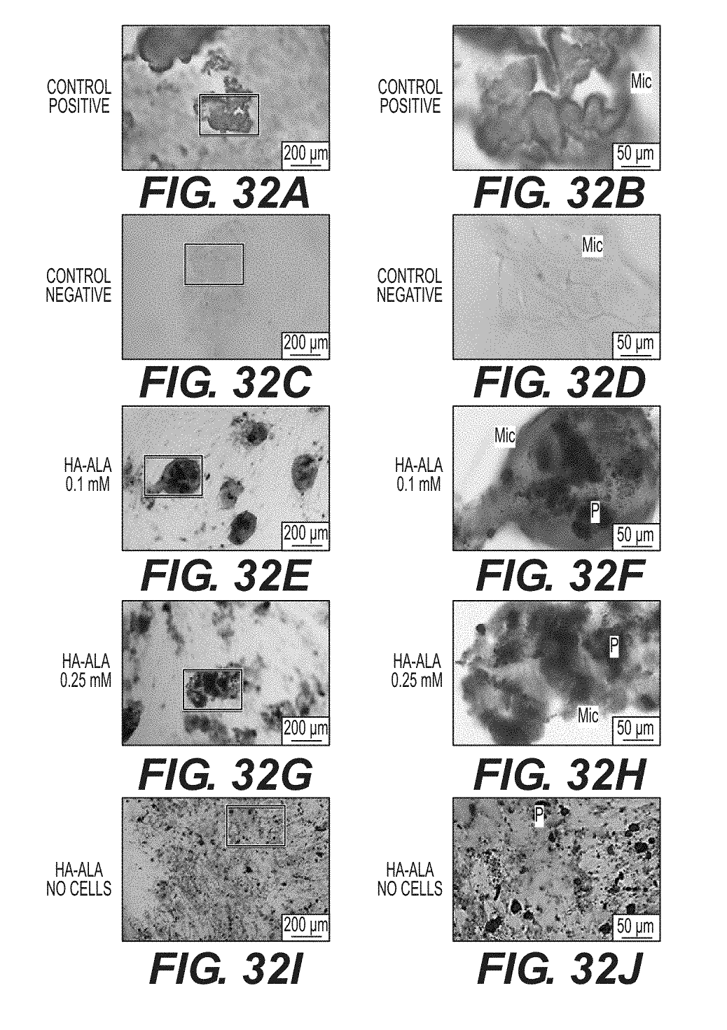

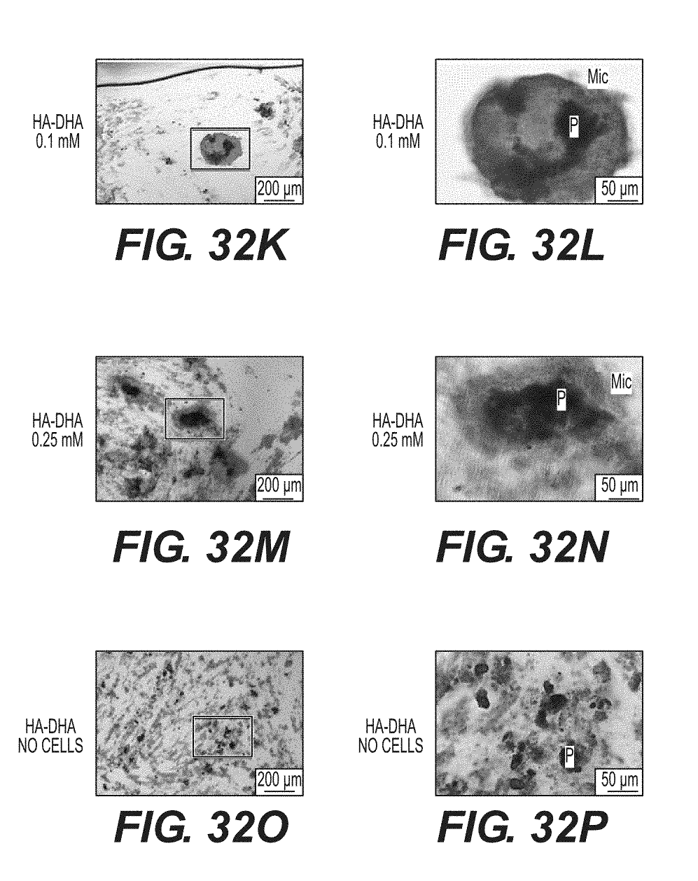

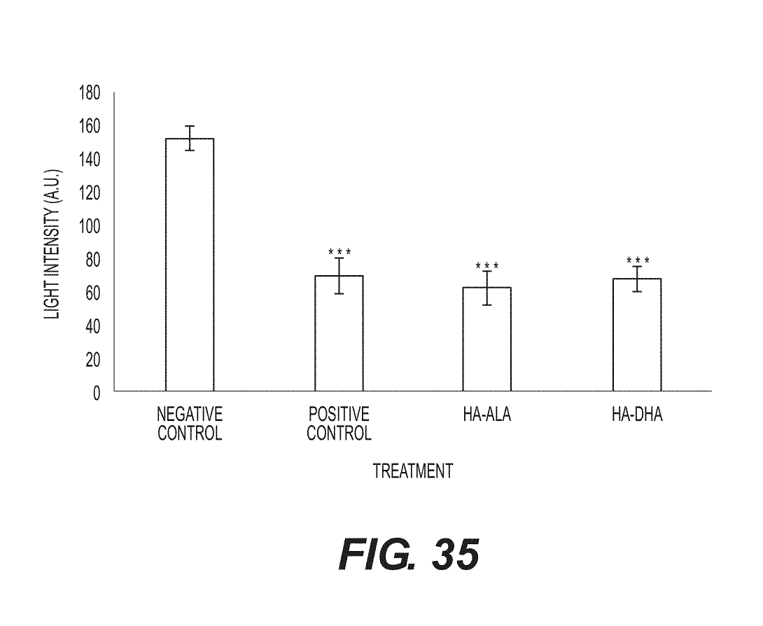

Dental pulp cells incubated on an extracellular matrix developed into microtissues. Formation, deposition and accumulation of minerals (these areas are depicted as lighter grey stain surrounding the microtissues in FIGS. 32A-P) in 3D cultures stained with Alizarin Red S reagent was observed for both bio-active composite materials at low (0.1 mM, FIGS. 32E-F and 32K-L; FIGS. 32F and 32L are magnifications of the boxed areas in FIGS. 32E and 32K, respectively) and high (0.25 mM, FIGS. 32G-H and 32M-N; FIGS. 32H and 32N are magnifications of the boxed areas in FIGS. 32G and 32M, respectively) concentrations. Substantive adhesion and accumulation of darkly stained bio-active composite material particles (P) on and in microtissue (Mic) are evident. This is contrasted by arbitrary spread of HA-ALA and HA-DHA as individual particles on the matrix without cells (FIGS. 32I-J and 32O-P; FIGS. 32J and 32P are magnifications of the boxed areas in FIGS. 32I and 32O, respectively), showing that the aggregation and adhesion effect is not caused by the matrix. Mineralization was also observed in 3D cell cultures induced with the calcifying medium (FIGS. 32A-B; FIG. 32B is a magnification of the boxed areas in FIG. 32A). Microtissues exposed only to growth media did not stain, indicating no mineral formation (FIGS. 32C-D; FIG. 32D is a magnification of the boxed areas in FIG. 32C). Quantified light intensity values of mineralizing microtissues incubated with the calcifying medium (POSITIVE CONTROL) HA-ALA and HA-DHA (69.65±10.24, 62.43±9.77, 68.03±7.67 AU, respectively), were similar and demonstrated a significant mineralization due to HA-ALA and HA-DHA treatment. As a result, these intensity values decreased significantly (p≤0.001), by more than a factor of two, relative to the non-mineralizing microtissues in FIG. 35 (152.15±7.05 AU).

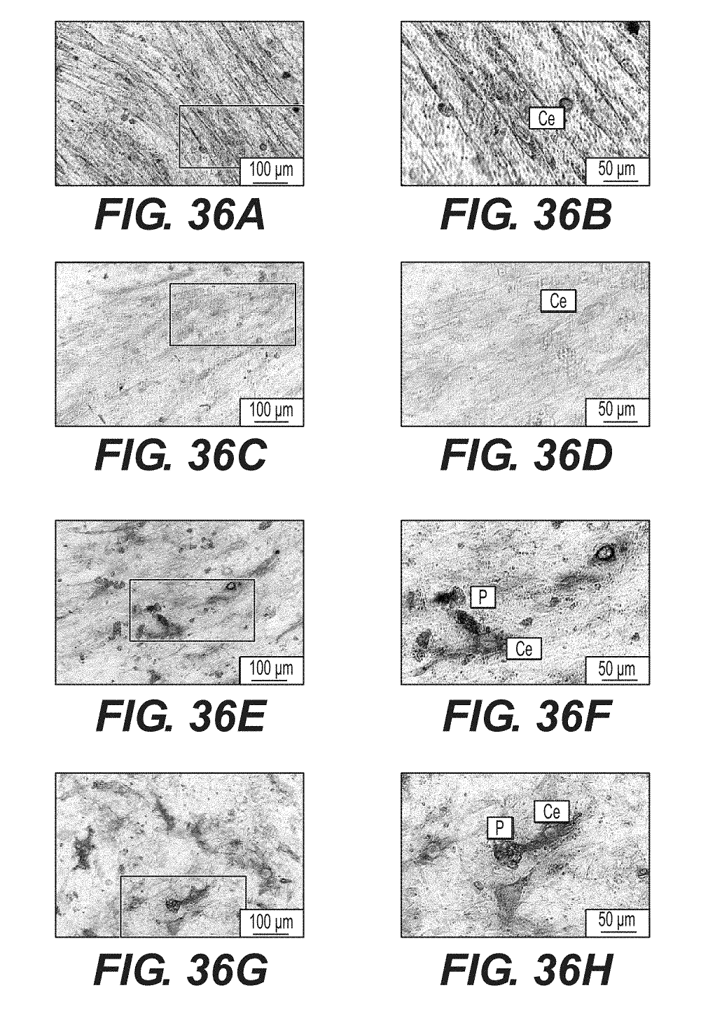

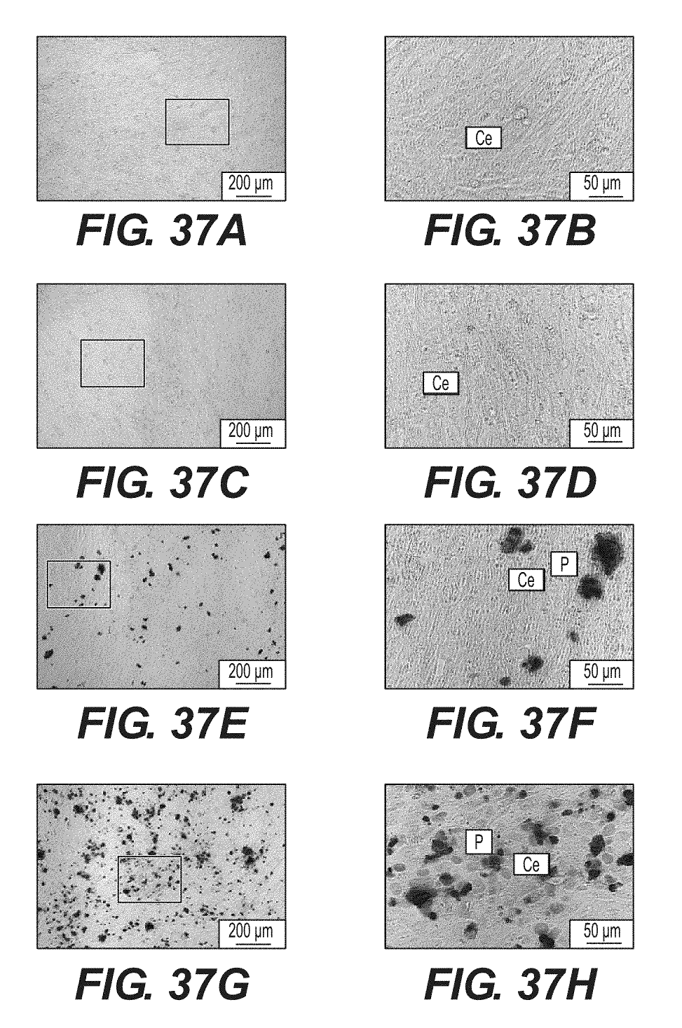

The inductive effect of HA-ALA and HA-DHA on the initial differentiation and calcification processes of human fetal osteoblasts was analyzed and demonstrated by alkaline phosphatase activity (FIGS. 36A-H) and mineral formation and deposition (FIGS. 37A-H) in 2D cultures. Alkaline phosphatase activity was detected in differentiated osteoblasts adhered to HA-ALA and HA-DHA (FIGS. 36E-F and 36 G-H, respectively; FIGS. 36F and 36H are magnifications of the boxed areas in FIGS. 36E and 36G, respectively). Osteoblasts treated with calcifying medium (FIGS. 36A-B; FIG. 36B is a magnification of the boxed areas in FIG. 36A) also displayed alkaline phosphatase activity. Osteoblast cell cultures treated with growth medium only (FIGS. 36C-D; FIG. 36D is a magnification of the boxed areas in FIG. 36C) demonstrated a low level of alkaline phosphatase activity.

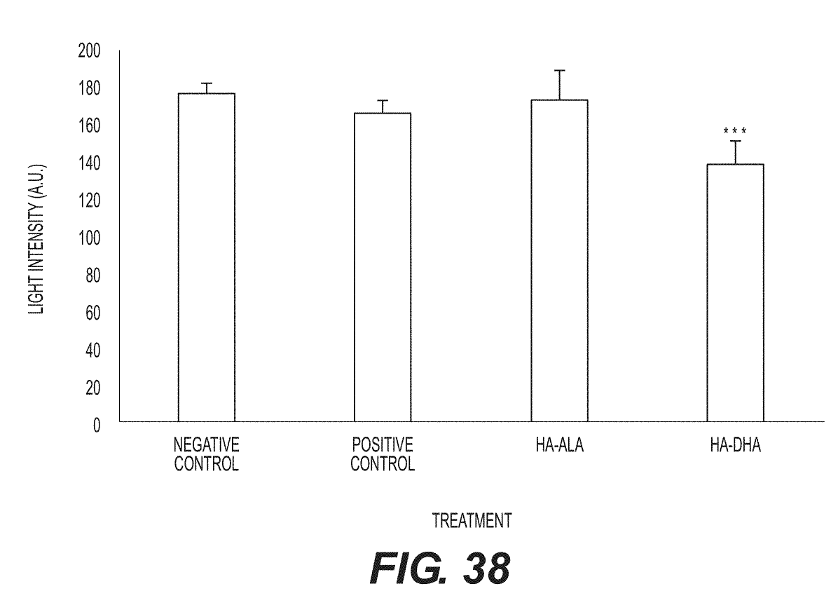

Osteoblasts treated with HA-ALA material (dark aggregated particles, P) did not stain with Alizarin Red, indicating that by day 11 mineral formation had not begun (FIGS. 37E-F; FIG. 36F is a magnification of the boxed areas in FIG. 36E). However, the detection of alkaline phosphatase for this treatment demonstrates a positive effect of this material on cell differentiation towards mineralizing osteoblasts. Osteoblasts treated with HA-DHA did stain with Alizarin Red S, which indicates the beginning of calcium deposition. HA-DHA was also observed to have an indirect effect on nearby osteoblasts since osteoblasts not in direct contact with any HA-DHA particles stained, indicating mineral formation (FIGS. 37G-H; FIG. 37H is a magnification of the boxed areas in FIG. 37G). Cells incubated with calcifying medium (FIGS. 37A-B; FIG. 37B is a magnification of the boxed areas in FIG. 37A) did not stain, indicating they have not started the calcification process. This result suggests that HA-DHA may shorten the time necessary to induce mineral formation relative to the standard calcifying medium. Osteoblasts exposed to growth media only did not show any mineral deposition (FIGS. 37C-D; FIG. 37D is a magnification of the boxed areas in FIG. 37C). HA-ALA and HA-DHA demonstrated substantivity by adhering to and aggregating on osteoblasts (FIGS. 37E-F and 37G-H, respectively). Quantified light intensity measurements of osteoblasts treated with HA-DHA (138.99±12.16 AU) showed a significant decrease (p≤0.001) of 38 AU compared to the NEGATIVE CONTROL group (177.24±5.37 AU) (FIG. 38). No significant differences were observed in the light intensity values of osteoblasts cultured with HA-ALA or calcifying medium after 11 days of incubation (166.63±6.53, 173.80±12.16 AU). This outcome indicates that HA-DHA induces the initial mineralization process in osteoblasts.

The herein disclosed bio-active composite materials may be used to deliver/deposit bio-active molecules directly to the site where they are needed: (1) bone or dental defect restorations (as grafting/restorative material or in combination with other grafting/restorative materials; as an additive to restorative materials such as inorganic based cements and polymer based cements); (2) coatings of implant devices (such as dental implants and bone implants); (3) dental dentifrices (such as toothpastes, varnishes, and rinses); (4) 3D printing of restorative materials (for example bone implants/scaffolds); (5) an additive to paints or varnishes where antimicrobial surface properties/release of antimicrobial agents are needed (6) orally, intravenously, or subcutaneously delivered/injected for pH controlled release of the functional group/s.

We claim:

1. A bio-active composite material, comprising:
an organic molecule or molecules having a first set of properties, the organic molecule or molecules, comprising:
a metal coordinating functional group; and
an inorganic core attached to the organic molecule, the inorganic core having a second set of properties and comprising one or more metals,
wherein the metals are chosen from one of a group consisting of noble metals and non-noble metals, the non-noble metals comprising one or more of alkali, alkaline earth, transition, post-transition, and metalloid metals,
wherein the organic molecule and inorganic core are attached using one of a covalent bond and a non-covalent bond,
wherein the bio-active composite material is used alone, or in conjunction with other materials, or is deposited on a target surface, and
wherein the organic molecule or molecules is controllably released, through hydrolysis of the bond or dissolution of the inorganic core, from the bio-active composite material, the organic molecule or molecules retaining the first set of properties.

2. The bio-active composite material of claim 1, further comprising additional reacting components added during formation of the bio-active composite material to alter the second set of properties of the inorganic core, the additional reacting components comprising halogen (fluoride, chloride, bromide, iodide) salts and transition/actinide/lanthanide salts.

3. The bio-active composite material of claim 1, comprising the inorganic core attached to saturated fatty acid or acids or their derivatives, unsaturated fatty acid or acids or their derivatives, and/or combinations of saturated fatty acids or their derivatives and unsaturated fatty acids and their derivatives.

4. The bio-active composite material of claim 3 used to reduce pro-inflammatory cytokines expression in human and other mammalian cells.

5. The bio-active composite material of claim 3 used to induce formation of pro-resolution mediators in human and other mammalian cells.

6. The bio-active composite material of claim 3 used to inhibit growth of microorganisms.

7. The bio-active composite material of claim 3 used to inhibit formation of biofilm created by microorganisms.

8. The bio-active composite material of claim 3 used to adhere to human and other mammalian cells.

9. The bio-active composite material of claim 3 used to induce mineral formation and deposition in human and other mammalian stem cells, pluripotent cells, dental pulp cells and osteoblasts.

10. A bio-active composition for use on a target surface, comprising:
an organic layer of one or more organic molecules consisting of:
one or more functional groups, the one or more functional groups consisting of one or more of a metal coordinating functional group, and
one or more of a carboxylic acid or orthophosphoric or hydroxyl group/groups, amines, amides, and nitrogen-containing aromatics,
wherein the functional groups comprise one or more of alkyl phosphine oxides, alkyl phosphonic acids, alkyl phosphines, saturated and unsaturated fatty acids and their derivatives;
an inorganic core of one or more inorganic molecules, the inorganic molecules comprising a metal or a mixture of metals, the metals chosen from a group consisting of noble metals and non-noble metals; and
a chemical bond between the organic layer and the inorganic core.

11. The bio-active composition of claim 10, wherein the non-noble metals comprise one or more metals chosen from a group consisting of alkali, alkaline earth, transition, post-transition, and metalloids.

12. The bio-active composition of claim 11, wherein the metals are produced from cations that are oxidized or that react with anionic species to precipitate as particles or form deposits on the target surface.

13. The bio-active composition of claim 10, wherein the noble metals comprise one or more metals chosen from a group consisting of one or more of Ru, Rh, Pd, Ag, Os, Ir, Pt, Au.

14. The bio-active composition of claim 13, wherein the metals are reduced or react with anionic species to precipitate as particles or form deposits on the target surface.

15. The bio-active composition of claim 10, wherein the inorganic core provides a controlled release of the organic molecules on the target surface.

16. The bio-active composition of claim 10, wherein the inorganic core further comprises additional reacting components chosen from a group consisting of halogen salts and transition/lanthanide salts.

17. A bio-active composite material, comprising:
an organic molecule or molecules having a set of biological properties, the organic molecule or molecules, comprising:
a metal coordinating functional group; and
an inorganic core attached to the organic molecule, the inorganic core comprising one or more metals,
wherein the metals are chosen from one of a group consisting of noble metals and non-noble metals, the non-noble metals comprising one or more of alkali, alkaline earth, transition, post-transition, and metalloid metals,
wherein the organic molecule and inorganic core are attached using one of a covalent bond and a non-covalent bond,
wherein the bio-active composite material is used alone, or in conjunction with other materials, or is deposited on a target surface to provide a controlled release of the organic molecule or molecules with the set of biological properties.

18. The bio-active composite material of claim 17, wherein the organic molecule or molecules provide controlled release of anti-inflammatory agents.

19. The bio-active composite material of claim 17, wherein the organic molecule or molecules provide controlled release of anti-microbial agents.

20. The bio-active composite material of claim 17, wherein the organic molecule or molecules provide controlled release of remineralizing agents.
